(19) United States
(12) Patent Application Publication
(10) Pub. No.: US 2024/0038025 A1
(43) Pub. Date: Feb. 1, 2024

(54) GRAPHICAL USER INTERFACES FOR GAMES OF CHANCE WITH DYNAMIC FEATURE GAME TRIGGER SYMBOL MECHANIC

(71) Applicant: Aristocrat Technologies, Inc., Las Vegas, NV (US)

(72) Inventors: Erick Ching, Cedar Park, TX (US); Amit Sharma, Gurugram (IN); Jennifer Mizzi, Ewa Beach, HI (US); Nathan Warms, Austin, TX (US); Shayer Waseem Shaik, Gurugram (IN)

(21) Appl. No.: 17/815,545

(22) Filed: Jul. 27, 2022

(51) Int. Cl. G07F 17/32

(52) U.S. Cl. CPC G07F 17/3267; G07F 17/3244; G07F 17/3213

(57) ABSTRACT

Graphical user interfaces (GUIs) are provided for presenting games of chance in which a symbol or symbols displayed in a designated proper subset of symbol positions in a reel display area are treated as feature game trigger symbols for a given play of a base game of the game of chance. In some instances, the appearance of a symbol of a particular symbol type in a symbol position in the proper subset of symbol positions may cause the number of symbol positions in the proper subset of symbol positions to be increased.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In some contexts, games of chance may include a base game, e.g., in which each play involves a random selection of symbols that are displayed in symbol positions within a reel display area and then evaluated to see if combinations of the symbols along any of several paylines form a winning pattern, and a feature game, e.g., a game mode that is typically triggered based on an event occurring during base game play and which features a different game play experience.

### SUMMARY

Discussed herein are GUIs for presenting games of chance that have feature games that are triggered when a threshold number of a particular symbol is shown in the reel display area as the result of a play of the base game of the game of chance. In most slot-machine type games of chance, the reel display area may display a plurality of symbols in symbol positions that are generally arranged as a horizontally arranged sequence of columns, with each column of symbol positions displaying symbols that are selected from a virtual reel, e.g., an ordered list of symbols that generally represent a “reel strip” as used in a conventional mechanical slot machine. In some such games of chance, the reel strips may include among the symbols listed therein feature game trigger symbols. When a sufficient number of such feature game trigger symbols are displayed in the reel display area as the result of a play of the game of chance, the feature game may be triggered.

However, the use of such feature game trigger symbols may present issues with respect to the design of GUIs for such games of chance. Feature game trigger symbols are typically not treated as being part of potential winning symbol patterns in base game winning symbol patterns. In such games of chance, a game outcome in which feature game trigger symbols are displayed may have a lower chance of including a winning symbol pattern in the base game since some of the symbol positions are occupied by feature game trigger symbols that are ineligible to be part of the winning outcome. In such games of chance, increasing the chance of triggering the feature game by increasing the number of feature game trigger symbols that are on the virtual reel strips may correspondingly decrease the chances of obtaining a winning outcome in the base game.

In some games of chance, this is avoided by having such feature game trigger symbols be dual-purpose, e.g., a symbol on a reel strip may be both a feature game trigger symbol and another symbol that is eligible to be part of a winning symbol pattern, e.g., a wild symbol that can be used in place of any symbol that is needed to form a winning symbol pattern. However, such implementations may offer little in the way of diverse game play experience, as the symbols that are dual-purpose would remain the same from play to play of the game.

In some other games of chance, the feature game trigger symbols may not be included in the reel strips at all but may, for example, be randomly added to various symbol positions in the reel display area dynamically. For example, in such implementations, each time the base game is played, a determination may be made as to how many feature game trigger symbols are to be displayed in the reel display area as part of the game play outcome (e.g., zero to X, where X is greater than or equal to the threshold number of feature game trigger symbols needed to trigger the feature game). Once the number of feature game trigger symbols to be displayed has been determined, then further random determinations of how to distribute that number of feature game trigger symbols among the various symbol positions in the reel display area may be made. Alternatively, a random determination may be made for each symbol position in the display area as to whether or not to display a feature game trigger symbol at that symbol position, e.g., each symbol position may have a 2% chance of having a feature trigger symbol displayed there for each play of the base game. In such implementations, the symbol positions that are selected to have a feature game trigger symbol displayed may, in effect, act as dual-purpose symbols—for determining winning patterns, the symbols from the reel strips that were selected for those symbol positions may be used, and for determining whether the feature game is triggered, the feature game trigger symbols for those symbol positions may be used. However, such GUI implementations offer a less satisfying user experience since there is no connection between the display of symbols from the virtual reel strips and the feature game trigger symbols. Thus, the player of the game is deprived of the excitement and anticipation that may arise, for example, from seeing feature game trigger symbols land in the reel display area as the virtual “reels” come to a stop and potentially realizing that they need only one or two more feature game trigger symbols to land from the remaining reel(s) that are still in motion in order to trigger the feature game. Moreover, due to how symbols that are on virtual reel strips are presented, e.g., as if they were on real mechanical reels that scroll through the reel display area, the player can see when a feature game trigger symbol on a virtual reel strip enters the reel display area and whether or not it is about to leave the reel display area. When feature game trigger symbols are not on the virtual reel strips but are instead directly assigned to symbol positions in the reel display area, this robs the player of the experience of seeing the feature game trigger symbols move into (and hopefully land within) the reel display area.

The present disclosure provides for a new mechanism for displaying feature game trigger symbols. In implementations discussed in more detail below, in each play of a base game of a game of chance a plurality of symbols may be displayed in a plurality of symbol positions in the reel display area. The symbol that is displayed in each symbol position may be one of a plurality of different symbol types that are included, for example, on virtual reel strips used in determining outcomes of the base game.

In at least some such game play instances, a proper subset of such symbol positions may be designated. In such game play instances, the symbol type(s) of the symbol(s) that are displayed within the symbol positions(s) in the proper subset of symbol positions may be treated as, for the purpose of determining whether or not the feature game is triggered, feature game trigger symbols, regardless of where symbols of that type of symbol or those types of symbols are displayed within the reel display area. Thus, for example, if the proper subset of symbol positions includes only a single symbol position and a “7” symbol is shown in that single symbol position, all of the symbols displayed in the reel display area that are “7” symbols (including the one in the proper subset of symbol positions) may be treated as feature game trigger symbols for that particular play of the game of chance. The feature game trigger symbols are thus dynamic in that the particular symbol(s) that is or are used as the feature game trigger symbol(s) may change with each play of the base game and is or are not even known until a symbol or symbols are displayed in the first proper subset of symbol positions. It will be understood that when reference to “displaying” a symbol in a symbol position is made in this disclosure, this is intended to refer to the display of a symbol in that symbol position for the purposes of determining a game play outcome. For example, in a slot-machine type game of chance, multiple different symbols may be caused to pass through a particular symbol position to simulate the movement of symbols on mechanical reels through that symbol position. This transient display of such symbols within the symbol position should be understood to not be considered a “display” of those symbols in the symbol position. When the symbols stop moving and come to rest within respective symbol positions, however, the presence of those symbols within their respective symbol positions is considered, for the purposes of this disclosure, a “display” of those symbols in their respective symbol positions.

The term “subset” in this application is to be understood to be a set that is composed of members of another set. A subset may have fewer members than the other set or the same members as the other set. A subset that has fewer members than the set that it is a subset of may be referred to herein as a “proper subset.” A subset that has the same members as the set it is a subset of may be referred to herein as an “improper subset.”

Such implementations provide GUIs in which the display of feature game trigger symbols can still be connected with the movements of symbols included in virtual reel strips, thus retaining the element of anticipation for a player that accompanies seeing potential feature game trigger symbols moving into the reel display area and potentially stopping within the reel display area. At the same time, there is also additional anticipation generated since, for each play of the base game of the game of chance, there is uncertainty as to which symbol(s) will be displayed in the symbol position(s) of the proper subset of symbol positions, and thus uncertainty as to which symbol type(s) will be the feature game trigger symbol(s) for that play of the base game.

In some implementations, such games of chance may further include the ability to “grow” the proper subset of symbol positions. For example, there may be a particular type or types of symbols that, when displayed in a symbol position of the proper subset of symbol positions, cause the number of symbol positions in the proper subset of symbol positions to be expanded—and symbols in the reel display area that have the same symbol type as any of the symbols displayed in the symbol positions in the expanded proper subset of symbol positions to be treated as feature game trigger symbols. In some such implementations, the reel area itself may also be expanded in conjunction with the expansion of the proper subset of symbol positions.

It is to be understood that the GUI implementations discussed herein, e.g., with regard to a dynamic feature game trigger symbol mechanism, provide a large variety of different potential gameplay experiences without requiring the creation and storage of different symbol sets for each such gameplay experience. For example, in each play of a base game, the particular symbols that will be treated as feature game trigger symbols can change depending on which symbols land within the proper subset of symbol positions. For example, if there are 16 different symbols that are able to land within a proper subset of symbol positions that includes only a single symbol position, this means there are potentially 16 different symbols that may potentially be treated as feature game trigger symbols for any given play of the base game. To create an equivalent experience using non-dynamic feature game trigger symbols, e.g., where the symbols are selected from reel strips that have feature game trigger symbols in predefined locations, sixteen different reel strip sets would need to be stored and then selected between prior to each play of the base game in which the feature game could potentially be triggered. The dynamic feature game trigger mechanism discussed herein, however, allows for such a gameplay experience to be provided using a lower number of reel strip sets, e.g., one reel strip set, thereby reducing the amount of memory that is required to provide such a gameplay experience.

It will be understood that at least the following implementations are within the scope of this disclosure, although it will be further understood that additional implementations beyond those explicitly listed below may also be evident from this disclosure, and the list provided below is not to be considered limiting.

In some implementations, a system may be provided that includes one or more displays, one or more processors, and one or more memory devices. The one or more memory devices may store computer-executable instructions which, when executed by the one or more processors, cause the one or more processors to cause a graphical user interface for a game of chance to be presented on the one or more displays, the graphical user interface including a plurality of N symbol positions, cause, for each symbol position and responsive to a signal indicating a play of the game of chance, a corresponding symbol to be displayed therein, wherein each displayed symbol is one of a plurality of different types of symbols, determine a first proper subset of the symbol positions, determine a first quantity of the symbols that are in a first set of one or more of the symbols, the first set of one or more of the symbols consisting of the displayed symbol or symbols that is or are of the same type of symbol as any symbol displayed in the first proper subset of the symbol positions, determine, for the play of the game of chance, whether a subset of the displayed symbols forms a winning pattern, and cause a feature game to be initiated responsive to the first quantity being greater than or equal to a first threshold.

In some implementations, the one or more memory devices may further store additional computer-executable instructions which, when executed by the one or more processors, further cause the one or more processors to associate a value with each symbol in the first set of one or more of the symbols and determine an award based, at least in part, on the values associated with the symbol or symbols in the first set of one or more of the symbols.

In some implementations, the first proper subset of the symbol positions may include only a single symbol position.

In some implementations, the symbol position or the symbol positions in the first proper subset of the symbol positions may be predetermined.

In some implementations, the one or more memory devices may further store additional computer-executable instructions which, when executed by the one or more processors, further cause the one or more processors to receive input indicative of a user selection of a second proper subset of the symbol positions and determine the first proper subset of the symbol positions by basing the first proper subset of the symbol positions on the second proper subset of the symbol positions.

In some implementations, the one or more memory devices may further store additional computer-executable instructions which, when executed by the one or more processors, further cause the one or more processors to determine the first proper subset of the symbol positions by randomly selecting one or more of the symbol positions.

In some implementations, the plurality of different types of symbols may include a first type of symbol and the one or more memory devices may further store additional computer-executable instructions which, when executed by the one or more processors, further cause the one or more processors to determine whether a symbol of the first type of symbol is displayed in the symbol position or one of the symbol positions in the first proper subset of the symbol positions and increase, responsive to determining that a symbol of the first type of symbol is displayed in the symbol position or one of the symbol positions in the first proper subset of the symbol positions, the number of symbol positions in the first proper subset of symbol positions prior to determining the first quantity of the symbols that are in the first set of one or more of the symbols.

In some such implementations, after the number of symbol positions in the first proper subset of symbol positions is increased, the symbol positions in the first proper subset of the symbol positions may be arranged in a linear array of symbol positions, each symbol position at either end of the linear array adjacent to another symbol position in the linear array, and each symbol position, if any, in the linear array and not at either end of the linear array adjacent to two other symbol positions in the linear array.

In some such implementations, the expanded first proper subset of symbol positions may have four or fewer symbol positions.

In some implementations, the symbols selected for display in the symbol positions in the first proper subset of symbol positions may be selected as a sequenced sub-group from a larger predefined sequenced group of symbols, the larger predefined sequenced group of symbols may include a sub-sequence of Z symbols that includes one symbol that is the first type of symbol, none of the symbols in the sub-sequence of Z symbols repeat within the sub-sequence of Z symbols, and Z may be equal to the number of symbol positions in the expanded first proper subset of symbol positions.

In some such implementations, the first or last symbol in the sub-sequence of Z symbols may be the one symbol that is the first type of symbol.

In some implementations, the one or more memory devices may further store additional computer-executable instructions which, when executed by the one or more processors, further cause the one or more processors to cause the GUI to include N+M symbol positions responsive to determining that a symbol of the first type of symbol is displayed in the symbol position or one of the symbol positions in the first proper subset of the symbol positions, wherein M is a positive integer.

In some such implementations, the feature game may be a hold-and-spin game that uses the N+M symbol positions.

In some implementations, the symbol positions may be arranged in a two-dimensional array having X symbol positions lying along one axis and Y symbol positions lying along a different axis, N may be an integer multiple of X, and M may be an integer multiple of X.

In some such implementations, the feature game may be a hold-and-spin game that uses the two-dimensional array of X by Y symbol positions.

In some implementations, the feature game may be a hold-and-spin feature game.

In some implementations, one or more non-transitory, computer-readable media storing computer-executable instructions may be provided. The computer-executable instructions, when executed by one or more processors, may cause the one or more processors to cause a graphical user interface for a game of chance to be presented on one or more displays, the graphical user interface including a plurality of N symbol positions, cause, for each symbol position and responsive to a signal indicating a play of the game of chance, a corresponding symbol to be displayed therein, wherein each displayed symbol is one of a plurality of different types of symbols, determine a first proper subset of the symbol positions, determine a first quantity of the symbols that are in a first set of one or more of the symbols, the first set of one or more of the symbols consisting of the displayed symbol or symbols that is or are of the same type of symbol as any symbol displayed in the first proper subset of the symbol positions, determine, for the play of the game of chance, whether a subset of the displayed symbols forms a winning pattern, and cause a feature game to be initiated responsive to the first quantity being greater than or equal to a first threshold.

In some implementations, the one or more non-transitory, computer-readable media may further store additional computer-executable instructions which, when executed by the one or more processors, further cause the one or more processors to associate a value with each symbol in the first set of one or more of the symbols and determine an award based, at least in part, on the values associated with the symbol or symbols in the first set of one or more of the symbols.

In some implementations, the first proper subset of the symbol positions may include only a single symbol position.

In some implementations, the symbol position or the symbol positions in the first proper subset of the symbol positions may be predetermined.

In some implementations, the one or more non-transitory, computer-readable media may further store additional computer-executable instructions which, when executed by the one or more processors, further cause the one or more processors to receive input indicative of a user selection of a second proper subset of the symbol positions and determine the first proper subset of the symbol positions by basing the first proper subset of the symbol positions on the second proper subset of the symbol positions.

In some implementations, the one or more non-transitory, computer-readable media may further store additional computer-executable instructions which, when executed by the one or more processors, further cause the one or more processors to determine the first proper subset of the symbol positions by randomly selecting one or more of the symbol positions.

In some implementations, the plurality of different types of symbols may include a first type of symbol and the one or more non-transitory, computer-readable media may further store additional computer-executable instructions which, when executed by the one or more processors, further cause the one or more processors to determine whether a symbol of the first type of symbol is displayed in the symbol position or one of the symbol positions in the first proper subset of the symbol positions and increase, responsive to determining that a symbol of the first type of symbol is displayed in the symbol position or one of the symbol positions in the first proper subset of the symbol positions, the number of symbol positions in the first proper subset of symbol positions prior to determining the first quantity of the symbols that are in the first set of one or more of the symbols.

In some implementations, after the number of symbol positions in the first proper subset of symbol positions is increased, the symbol positions in the first proper subset of the symbol positions are arranged in a linear array of symbol positions, each symbol position at either end of the linear array adjacent to another symbol position in the linear array, and each symbol position, if any, in the linear array and not at either end of the linear array adjacent to two other symbol positions in the linear array.

In some such implementations, the expanded first proper subset of symbol positions may have four or fewer symbol positions.

In some implementations, the symbols selected for display in the symbol positions in the first proper subset of symbol positions may be selected as a sequenced sub-group from a larger predefined sequenced group of symbols, the larger predefined sequenced group of symbols may include a sub-sequence of Z symbols that includes one symbol that is the first type of symbol, none of the symbols in the sub-sequence of Z symbols may repeat within the sub-sequence of Z symbols, and Z may be equal to the number of symbol positions in the expanded first proper subset of symbol positions.

In some such implementations, the first or last symbol in the sub-sequence of Z symbols may be the one symbol that is the first type of symbol.

In some implementations, the one or more non-transitory, computer-readable media may further store additional computer-executable instructions which, when executed by the one or more processors, further cause the one or more processors to cause the GUI to include N+M symbol positions responsive to determining that a symbol of the first type of symbol is displayed in the symbol position or one of the symbol positions in the first proper subset of the symbol positions, wherein M is a positive integer.

In some such implementations, the feature game may be a hold-and-spin game that uses the N+M symbol positions.

In some implementations, the symbol positions may be arranged in a two-dimensional array having X symbol positions lying along one axis and Y symbol positions lying along a different axis, N may be an integer multiple of X, and M may be an integer multiple of X.

In some implementations, the feature game may be a hold-and-spin game that uses the two-dimensional array of X by Y symbol positions. In some such implementations, the feature game may be a hold-and-spin feature game.

In some implementations, a method may be provided that includes causing a graphical user interface for a game of chance to be presented on one or more displays, the graphical user interface including a plurality of N symbol positions, causing, for each symbol position and responsive to a signal indicating a play of the game of chance, a corresponding symbol to be displayed therein, wherein each displayed symbol is one of a plurality of different types of symbols, determining a first proper subset of the symbol positions, determining a first quantity of the symbols that are in a first set of one or more of the symbols, the first set of one or more of the symbols consisting of the displayed symbol or symbols that is or are of the same type of symbol as any symbol displayed in the first proper subset of the symbol positions, determining, for the play of the game of chance, whether a subset of the displayed symbols forms a winning pattern, and causing a feature game to be initiated responsive to the first quantity being greater than or equal to a first threshold.

In some implementations, the method may further include associating a value with each symbol in the first set of one or more of the symbols and determining an award based, at least in part, on the values associated with the symbol or symbols in the first set of one or more of the symbols.

In some implementations, the first proper subset of the symbol positions may include only a single symbol position.

In some implementations, the symbol position or the symbol positions in the first proper subset of the symbol positions may be predetermined.

In some implementations, the method may further include receiving input indicative of a user selection of a second proper subset of the symbol positions and determining the first proper subset of the symbol positions by basing the first proper subset of the symbol positions on the second proper subset of the symbol positions.

In some implementations, the method may further include determining the first proper subset of the symbol positions by randomly selecting one or more of the symbol positions.

In some implementations, the plurality of different types of symbols may include a first type of symbol and the method may further include determining whether a symbol of the first type of symbol is displayed in the symbol position or one of the symbol positions in the first proper subset of the symbol positions and increasing, responsive to determining that a symbol of the first type of symbol is displayed in the symbol position or one of the symbol positions in the first proper subset of the symbol positions, the number of symbol positions in the first proper subset of symbol positions prior to determining the first quantity of the symbols that are in the first set of one or more of the symbols.

In some implementations, after the number of symbol positions in the first proper subset of symbol positions is increased, the symbol positions in the first proper subset of the symbol positions may be arranged in a linear array of symbol positions, each symbol position at either end of the linear array adjacent to another symbol position in the linear array, and each symbol position, if any, in the linear array and not at either end of the linear array adjacent to two other symbol positions in the linear array.

In some implementations, the expanded first proper subset of symbol positions may have four or fewer symbol positions.

In some implementations, the symbols selected for display in the symbol positions in the first proper subset of symbol positions may be selected as a sequenced sub-group from a larger predefined sequenced group of symbols, the larger predefined sequenced group of symbols may include a sub-sequence of Z symbols that includes one symbol that is the first type of symbol, none of the symbols in the sub-sequence of Z symbols may repeat within the sub-sequence of Z symbols, and Z may be equal to the number of symbol positions in the expanded first proper subset of symbol positions.

In some implementations, the first or last symbol in the sub-sequence of Z symbols may be the one symbol that is the first type of symbol.

In some implementations, the method may further include causing the GUI to include N+M symbol positions responsive to determining that a symbol of the first type of symbol is displayed in the symbol position or one of the symbol positions in the first proper subset of the symbol positions, wherein M is a positive integer.

In some such implementations, the feature game may be a hold-and-spin game that uses the N+M symbol positions.

In some implementations, the symbol positions may be arranged in a two-dimensional array having X symbol positions lying along one axis and Y symbol positions lying along a different axis, N may be an integer multiple of X, and M may be an integer multiple of X.

In some such implementations, the feature game may be a hold-and-spin game that uses the two-dimensional array of X by Y symbol positions.

In some implementations, the feature game may be a hold-and-spin feature game.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4-19 depict example instances of a GUI having a dynamic feature game trigger symbol mechanism.

FIG. 20 depicts a flow chart for providing a game of chance having a dynamic feature game trigger symbol mechanism.

FIG. 21 depicts a flow chart for providing a feature game.

The Figures are provided for the purpose of providing examples and clarity regarding various aspects of this disclosure, and are not intended to be limiting.

### DETAILED DESCRIPTION

As discussed above, in each play of a base game of a game of chance a plurality of symbols may be displayed in a plurality of symbol positions in the reel display area. The symbol that is displayed in each symbol position may be one of a plurality of different symbol types that are included, for example, on virtual reel strips used in determining outcomes of the base game (or that are otherwise selected).

In at least some such game play instances, a proper subset of such symbol positions may be designated. In such game play instances, the symbol type(s) of the symbol(s) that are displayed within the symbol positions(s) in the proper subset of symbol positions may be treated as, for the purpose of determining whether or not the feature game is triggered, feature game trigger symbols, regardless of where symbols of that type of symbol or those types of symbols are displayed within the reel display area.

In some implementations, such games of chance may further include the ability to “grow” the proper subset of symbol positions. For example, there may be a particular type or types of symbols that, when displayed in a symbol position of the proper subset of symbol positions, cause the number of symbol positions in the proper subset of symbol positions to be expanded—and symbols in the reel display area that have the same symbol type as any of the symbols displayed in the symbol positions in the expanded proper subset of symbol positions to be treated as feature game trigger symbols. In some such implementations, the reel area itself may also be expanded in conjunction with the expansion of the proper subset of symbol positions.

The following discussion provides overall context for gaming machines that may be used to implement GUIs such as are described above and later herein. Following this overview, a more focused discussion of the GUI concepts discussed above is provided.

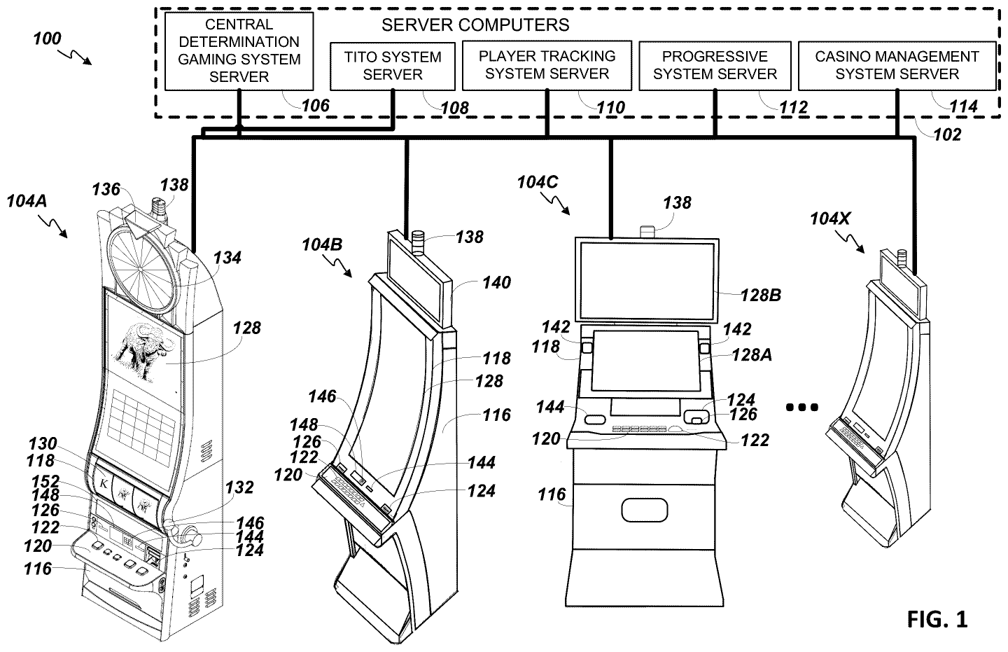

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

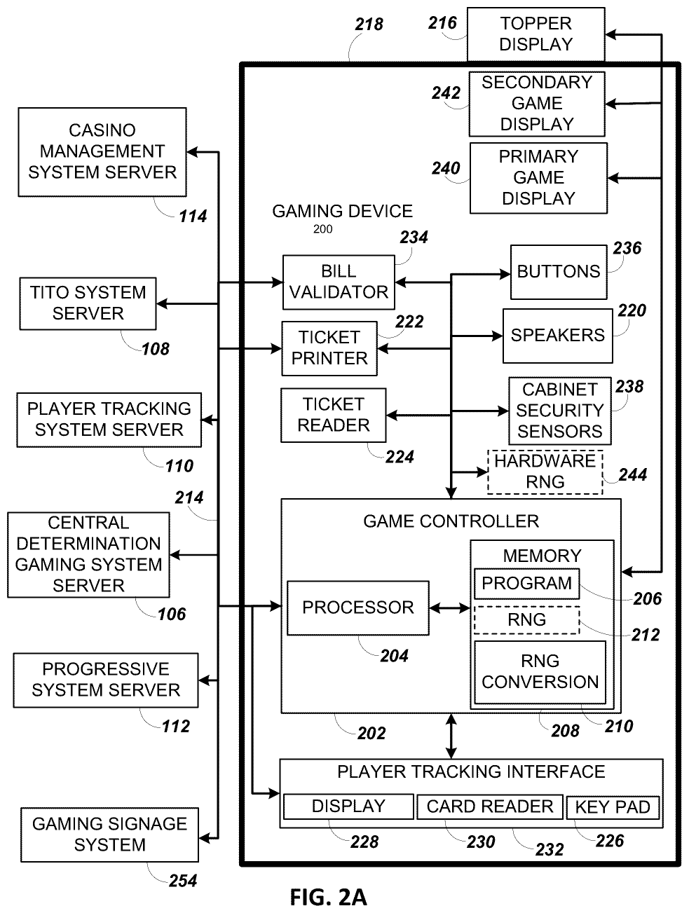

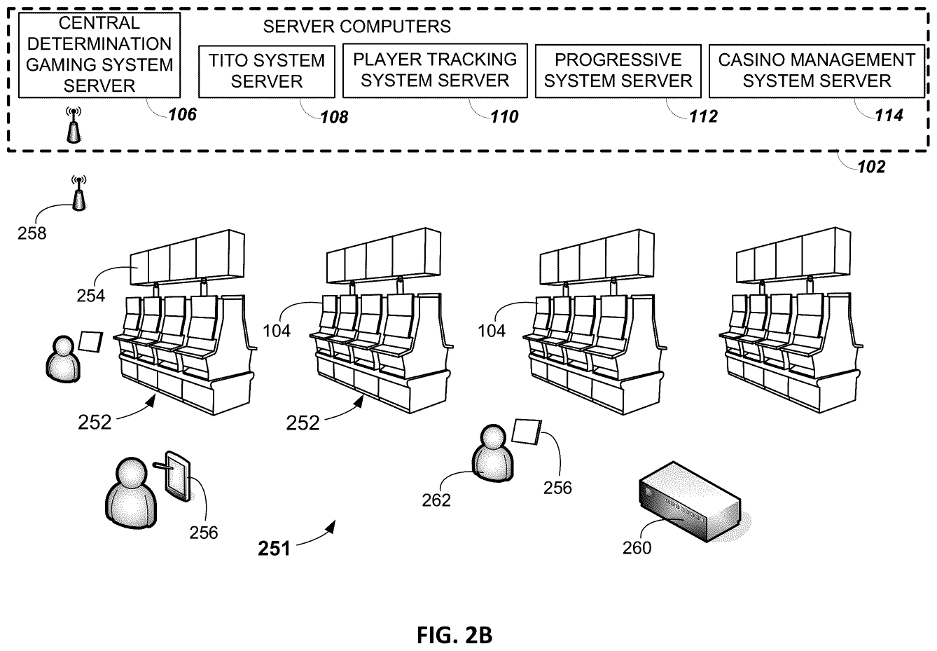

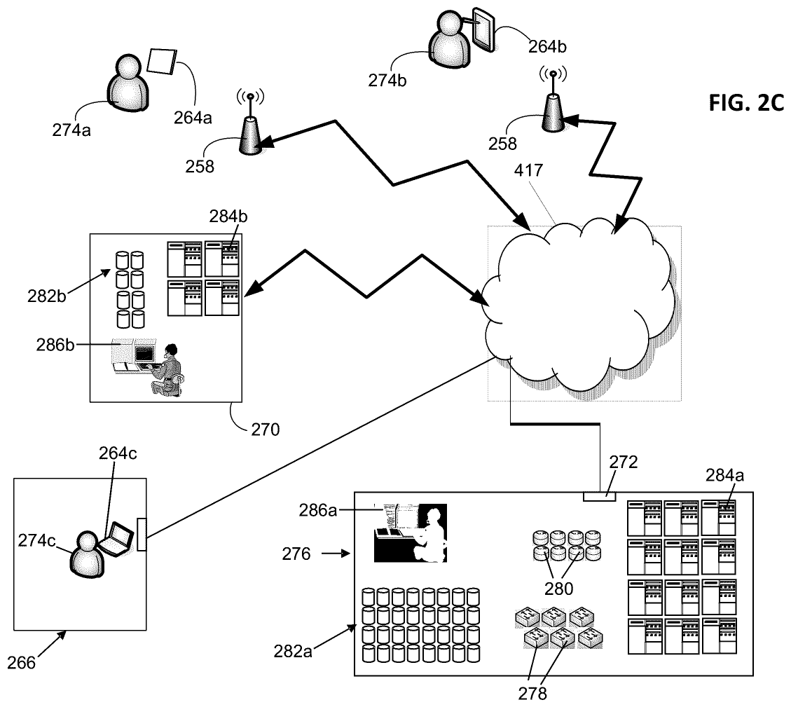

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc′ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 1288 is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

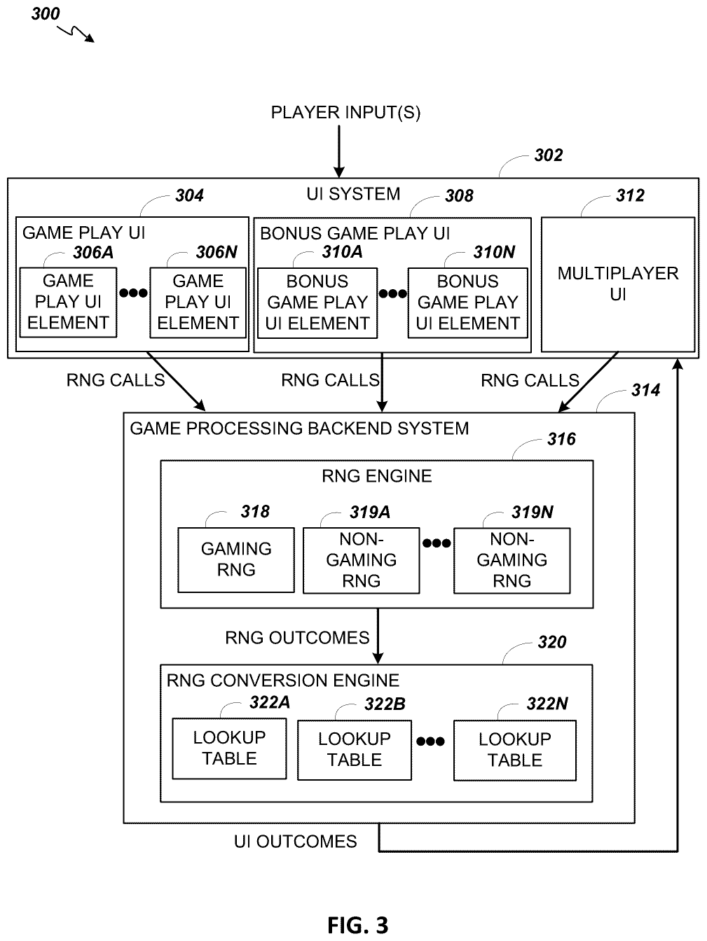

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

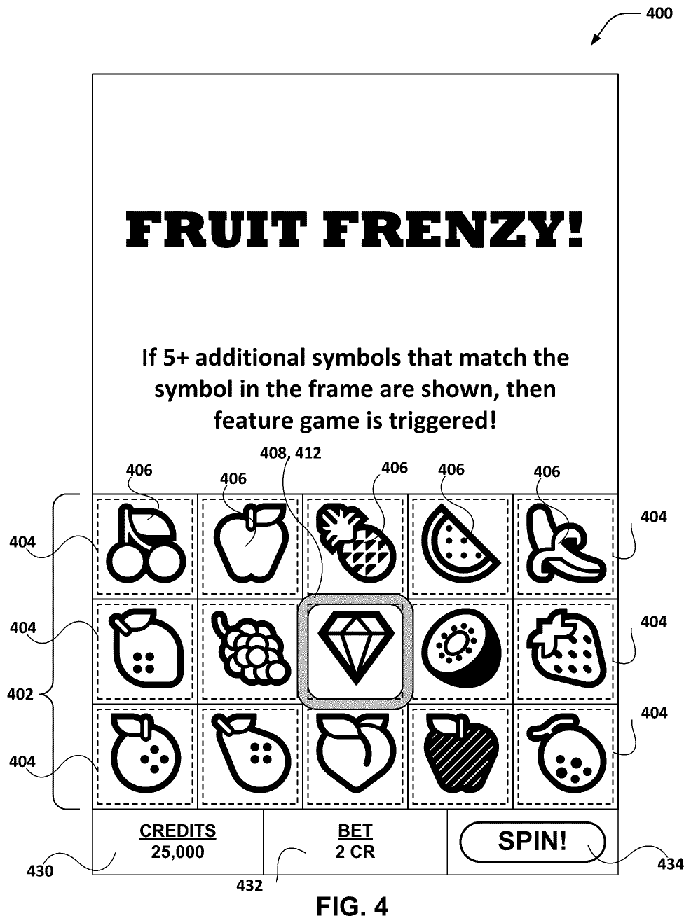

FIG. 4 depicts an example GUI 400 for displaying a base game of a game of chance. In FIG. 4, the GUI 400 includes a reel display area 402 that includes a plurality of symbol positions 404 (indicated by fifteen dashed squares in FIG. 4; later figures omit explicitly indicating such symbol positions 404, but it will be understood that such symbol positions 404 are present nonetheless). During each play of the base game of the game of chance, symbols 406 selected from a plurality of different types of symbols are selected and displayed in the symbol positions 404, e.g., one symbol 406 is displayed in each of the symbol positions 404. Such symbols 404 may, for example, be selected from adjacent positions at a particular location of a virtual reel strip responsive to a random outcome generated by a random number generator. However, it will be understood that the symbols 406 may be selected using other selection techniques as well, and that the base game may not utilize virtual reel strips or even reels—reference to the reel display area is to therefore be understood to be more generic and to be applicable to generally any display region that is used to display symbols that may be displayed during a play of the base game of chance and that are “in play,” e.g., available to form potentially winning patterns during a corresponding play of the base game.

In the GUI 400, there are fifteen symbol positions 404 in the reel display area 402 arranged in a 5×3 rectangular array. In other implementations, other arrangements of symbol positions 404 may be used, e.g., 3×5, 6×3, 3×6, 6×4, 4×6, etc., including arrangements that are not rectangular or bi-axial arrays.

In at least some (and in some cases, all) instances of game play of the base game of the game of chance, a first proper subset 408 of the symbol positions 404 in the reel display area 402 may be designated. The first proper subset 408, in this case, includes only a single symbol position 404 (in the middle column and middle row of the 5×3 array of symbol positions 404). Additionally, the first proper subset 408 is indicated in the GUI 400 by a frame 412 that encloses the symbol position 404 that is within the first proper subset 408 of symbol positions 404. It will be understood that the first proper subset 408 of symbol positions 404 may, in some implementations, include more than one symbol position 404. It will be further understood that first proper subsets 408 that include multiple symbol positions 404 may include symbol positions 404 that form a contiguous region within the reel display area 402 (e.g., in which each symbol position 404 shares an edge with one or more other symbol positions 404) or may, e.g., form two or more discontiguous regions within the reel display area 402 (e.g., in which at least one symbol position 404 does not share an edge with another symbol position 404).

As indicated in the region above the reel display area 404, the game of chance in this example is titled “Fruit Frenzy!,” and the symbols 406 shown in the reel display area 402 are generally different types of fruit. In this example, FIG. 4 depicts one of each of fifteen different types of symbol 406 that may be shown in the reel display area 402 responsive to a play of the game of chance. A sixteenth type of symbol, a “grow” symbol 406 that is in the form of an upward-pointing arrow, is also potentially able to be shown in the reel display area 402. It will be understood that the pool of different symbol types from which symbols 406 may be selected may have fewer or more (or the same number of) types of symbols 406 than there are symbol positions 404 that are in the GUI 400.

The region above the reel display area 402 also displays information on how a feature game associated with the game of chance may be activated or triggered. As indicated, if a play of the base game of the game of chance results in at least five symbols 406 of the same type as the symbol 406 or symbols 406 that are in the frame 412 (i.e., displayed in any symbol position 404 in the proper subset 408 of symbol positions 404), this causes the feature game of the game of chance to be triggered. Thus, in this example, if there are 6+ symbols 406 of the same type as the symbol 406 shown within the frame 412 visible in the reel display area 402, the feature game will be triggered.

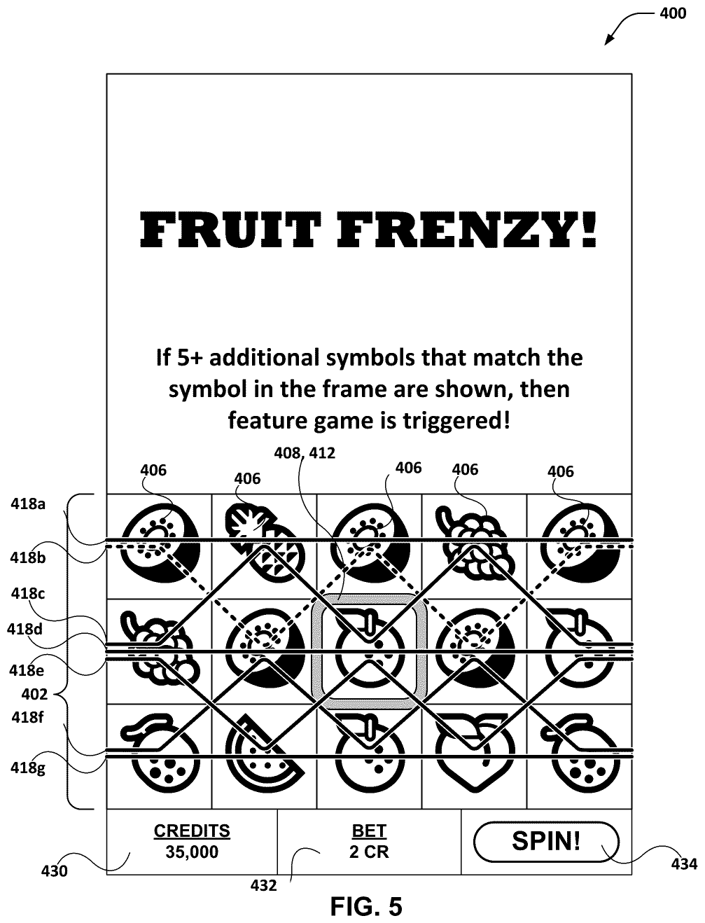

For a sense of how the feature game triggering mechanism in a base game such as is discussed above may function, reference is made to FIGS. 5 through 8. In FIG. 5, a play of the base game of the game of chance has been initiated, thereby resulting in a new selection of symbols 406 being made and caused to be displayed in the symbol positions 404 of the reel display area 402. Such a selection may be made randomly, e.g., output from a random number generator may be used to select random sets of adjacent symbols 406 from a virtual reel strip that are then caused to be displayed in, for example, corresponding sets of symbol positions 404, e.g., the symbol positions 404 that are in a similar set of adjacent symbol positions 404 that form a column of symbol positions 404.

In the base game of the game of chance, the symbols 406 that are displayed in the symbol positions 404 may be evaluated to determine if any winning patterns are formed. For example, the base game may have associated therewith a plurality of paylines 418 that each pass through a plurality of symbol positions 404. The symbols 406 that each payline 418 sequentially passes through may be evaluated to determine if that sequence of symbols 406 forms a pattern of symbols 406 that is associated with a particular winning outcome. In FIG. 5, there are seven paylines 418a through 418g shown, although it will be understood that more or fewer such paylines 418 may be used in any particular game of chance (or, alternatively, the game of chance may have a base game that determines winning symbol patterns according to some other system other than using paylines 418). In the example game of chance, winning patterns are achieved when any payline 418 has the same type of symbol 406 displayed in each symbol position 404 through which it passes. Of course, other games of chance may use other sets of winning patterns, including patterns in which not all symbols are of the same type or where only a subset of the symbols must be of the same type. In FIG. 5, the play of the game of chance has resulted in a winning pattern in the base game along the payline 418b—five kiwi symbols 406, in this case. Such a winning pattern may cause the player to be awarded, for example, credits that may be based on the type of symbol 406 and/or the specific winning pattern. In the GUI 400 of FIG. 4 (and subsequent Figures), a credit indicator 430 is provided that indicates a number of credits that the player has available to use for making bets, e.g., per bet indicator 432. A play button 434 is also provided; when a player selects the play button during base game play, a play of the base game of the game of chance may be initiated using a wager in the amount indicated by the bet indicator 432. As seen in FIG. 5, the credit indicator 430 reflects a 10,000 credit increase as compared with the value shown in FIG. 4 due to the winning pattern achieved along the payline 418b.

Such base game winning outcome determinations may be made for each play of the base game according to whatever mechanism the game of chance uses in determining winning events during base game play. The remainder of this discussion will, however, omit reference to base game winning outcome determinations in the interest of brevity.

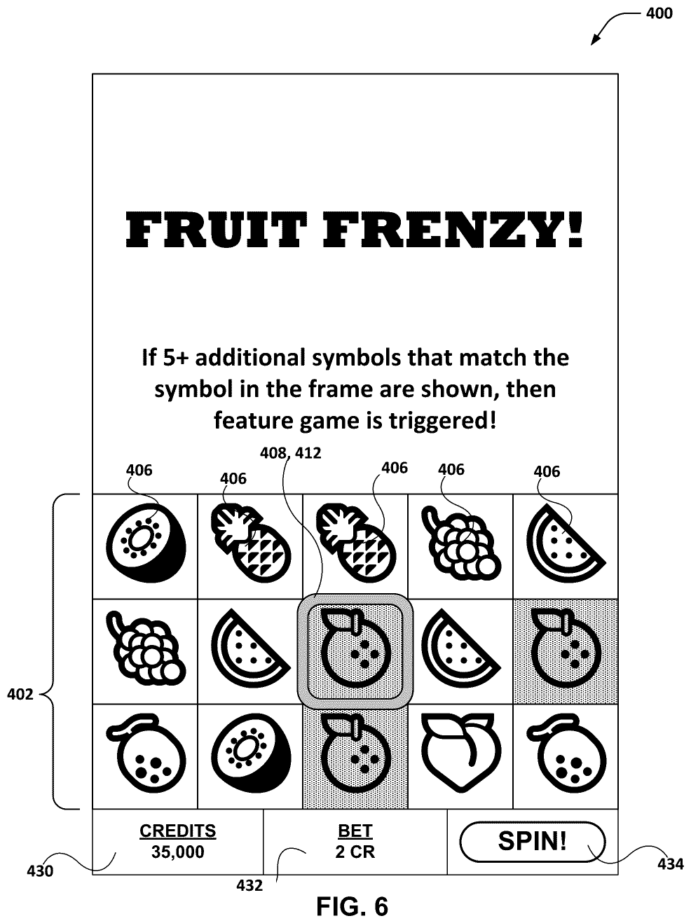

After determining whether any winning outcomes result from base game play of the game of chance, the type of symbol (or types of symbols) that are in the first proper subset 408 of symbol positions 404 may be determined. In this example, the symbol 406 that is in the single symbol position 404 of the first proper subset 408 of symbol positions 404 is an orange symbol. After identifying the symbol type(s) of the symbol(s) 406 in the first proper subset 408 of symbol positions 404, a further determination may be made as to how many of the symbols 406 displayed in the symbol positions 404 of the reel display area 402 are of the same symbol type(s) as any of the symbol type(s) of the symbol(s) 406 in the first proper subset 408 of symbol positions 404. In the game play of FIG. 5, there are three symbols 406 of the “orange” type of symbol 406, which are highlighted in FIG. 6, shown in the reel display area 402. These symbols 406 are then treated as feature game trigger symbols; reference to “feature game trigger symbols” in the discussion below will be understood to refer to any symbols 406 that are shown in the reel display area 402 for a given play of the base game of the game of chance that have the same symbol type as any of the symbols 406 shown in the symbol positions 404 of the first proper subset 408 of the symbol positions 404 for that play of the base game.

The number of feature game trigger symbols may then be compared against a first threshold to see if sufficient feature game trigger symbols have been obtained during that play of the base game to cause the feature game to be triggered and provided. As noted earlier, the example game of chance requires that six or more feature game trigger symbols be obtained during play of the base game in order to trigger the feature game. In the case of the game play outcome of FIGS. 5 and 6, the number of feature game trigger symbols is insufficient to trigger the feature game.

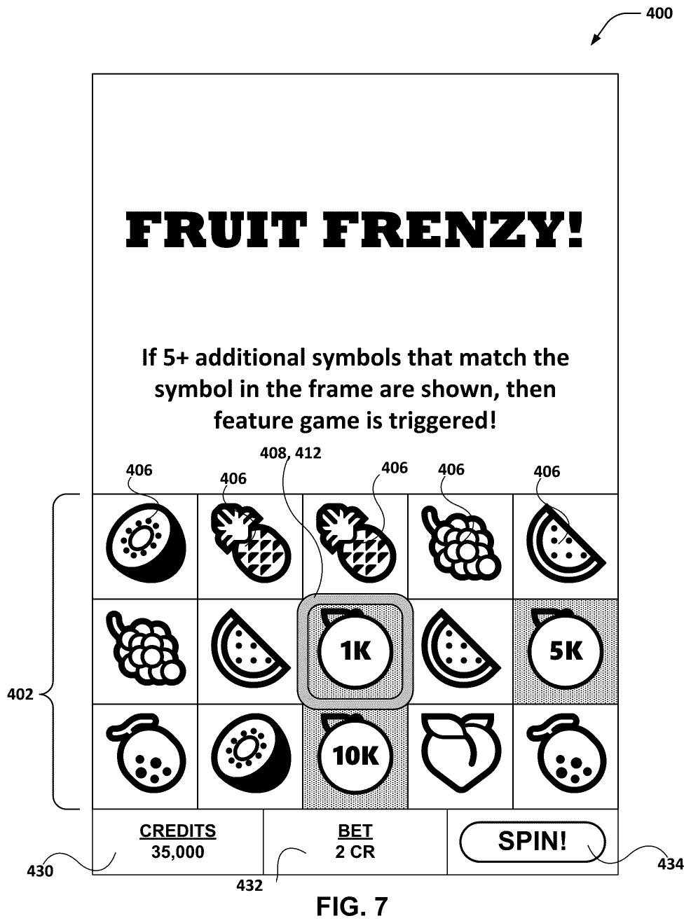

In some implementations, the feature game trigger symbols may each be associated with some award, e.g., a specific credit amount, a multiplier that multiplies any win amount achieved in that play of the base game, a power-up that may be later redeemed by the player to provide a specified type of advantage in a later play of the game of chance, etc. FIG. 7 depicts an example in which the feature game trigger symbols in the GUI 400 of FIG. 6 have been augmented with values associated with each of the feature game trigger symbols. In this example, the values indicate a number of credits associated with each feature game trigger symbol.

In some implementations, the awards associated with feature game trigger symbols may be not be displayed (or even determined) if the number of feature game trigger symbols displayed in the reel display area 402 is insufficient to trigger the feature game. In other implementations, the awards associated with feature game trigger symbols may be provided to the player for each play of the base game. In yet other implementations, a random determination may be made for each play of the base game as to whether the awards associated with the feature game trigger symbols that are displayed for that play of the base game will be awarded to the player. In yet further implementations, the awards associated with the feature game trigger symbols may be tracked from play to play of the base game and, when a particular condition or set of conditions is met with regard to the tracked awards as the result of a particular play of the base game, the awards associated with the feature game trigger symbols displayed as part of that particular play of the base game may be provided to the player. For example, if the awards are credit values, as shown in FIG. 7, there may be a meter that tracks the cumulative total of credit values that are associated with the feature game trigger symbols from base game play to base game play. When that meter reaches a predetermined threshold value, then the credit values associated with the feature game trigger symbols that are displayed when the meter reaches that predetermined threshold value may be awarded to the player.

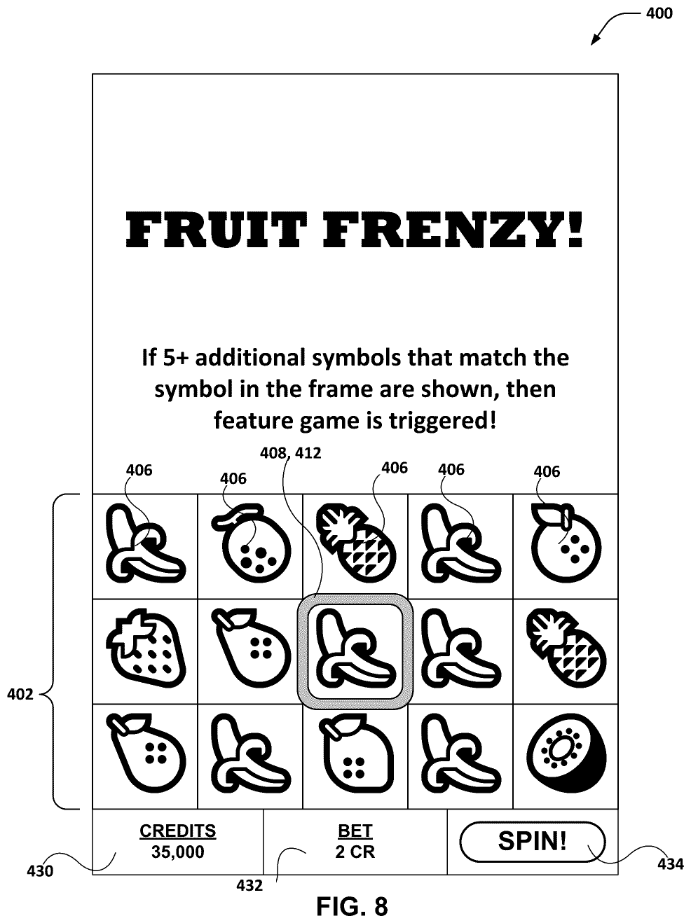

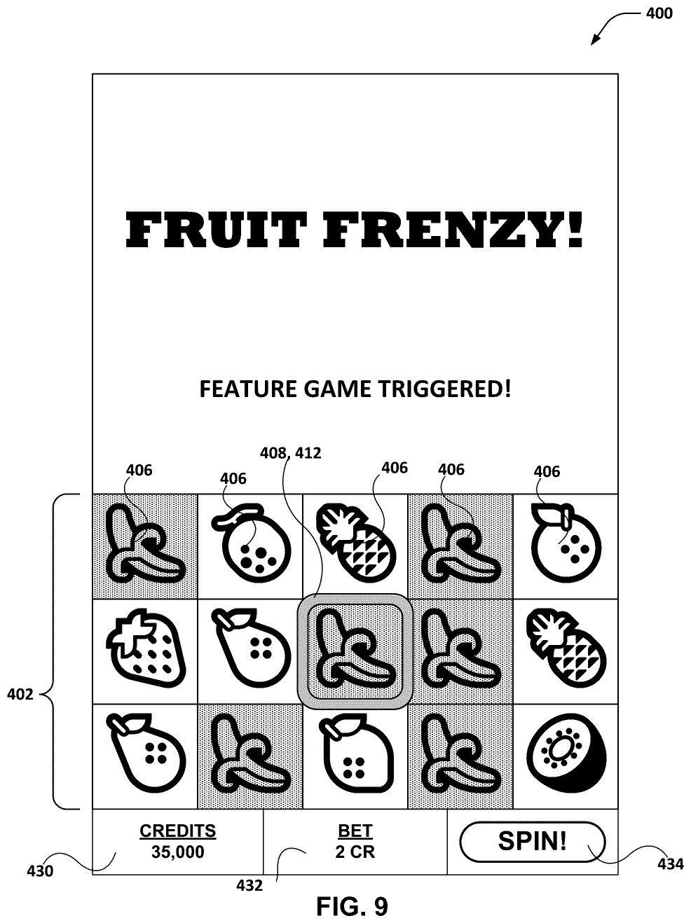

In FIG. 8, a new play of the base game has occurred and a new set of symbols 406 displayed in the symbol positions 404. In this particular play of the base game, the symbol 406 that is displayed in the symbol position 404 of the first proper subset 408 of the symbol positions 404 is has a symbol type of “banana.” As shown in FIG. 9, there are six symbol positions 404 that display symbols 406 of the “banana” symbol type, i.e., that are treated as feature game trigger symbols. This meets the first threshold of feature game trigger symbols needed to trigger the feature game, and the feature game, as indicated in the information area above the reel display area 402, may be activated or triggered.

It will be understood while the following discussion provides an example of a feature game that may be provided responsive to the first threshold of feature game trigger symbols being displayed in the reel display area, any feature game may be provided in response to the first threshold of feature game trigger symbols being displayed in the reel display area, and the scope of this disclosure is not to be limited to only the specific example discussed below.

The feature game in this example is a “hold-and-spin” feature game, in which the player is provided with some number, e.g., three, “free” spins (plays) of the feature game. In such a feature game, one or more types of symbols are “held” in place, i.e., in the symbol position in which they are initially displayed during the feature game, after being displayed in the feature game. Moreover, each time a play of the feature game results in a new instance of such a symbol being “held,” the number of plays of the feature game that the player has remaining may be reset or otherwise increased. The feature game may conclude when the player either runs out of plays of the feature game or all of the symbol positions 404 in the reel display area 402 display “held” symbols 406. At conclusion of the feature game, various implementations may provide awards in different manners.

In some implementations, there may be a pre-set award or awards that are provided based on the number of held symbols that are present at the conclusion of the feature game, e.g., 500 credits for 6 to 9 held symbols, 1000 credits for 10 held symbols, 2000 credits for 11 held symbols, 3000 credits for 12 held symbols, 5000 credits for 13 held symbols, 10,000 credits for 14 held symbols, and 20,000 credits for 15 held symbols.

In other implementations, the player may be awarded the values (if any) that are associated with the held symbols that are present at the conclusion of the feature game, regardless of the number of held symbols. In some implementations, the player may only be awarded the values associated with the held symbols if the feature game concludes with held symbols (or the symbols that would normally be held if there were subsequent play of the feature game) in all of the symbol positions 404 of the reel display area 402.

Finally, in some implementations, there may actually be no award at the conclusion of feature game play. In such implementations, awards may be provided during feature game play, as discussed below.

Awards may also optionally be provided during feature game play prior to the conclusion of the feature game. For example, in some implementations, each time a symbol 406 is newly displayed as a result of a feature game play and then held (or is of a symbol type that would be held if there were to be an immediately subsequent play of the feature game), an award associated with the newly held symbol 406 may be provided to the player. Such implementations may be particularly well-suited for implementations in which there is no award at the conclusion of the feature game play unless all of the symbol positions 404 are occupied by held symbols 406 or at all—in such an example, players may receive awards as feature game play progresses, but may, in some cases, have the possibility of earning another award if all of the symbol positions 404 at the conclusion of play have held symbols displayed therein.

The one or more types of symbols that may be “held” during feature game play may, for example, be the same type or types of symbols that are treated as feature game trigger symbols for the purpose of triggering the feature game. In some such implementations, such as that shown in FIGS. 4 through 19, the feature game trigger symbols that caused the feature game to trigger may be retained (held) in their symbol positions 404 at the start of the feature game, thereby providing the player with a “head start” on obtaining held symbols 406 in all of the symbol positions 404 of the reel display area 402. In some such implementations, if there are awards associated with the feature game trigger symbols that trigger the feature game, those awards may be provided to the player in association with initiating the feature game.

In some implementations, the symbol type or symbol types that are “held” during such a feature game may be completely different from the symbol type that is used as the feature game trigger symbol. In such implementations, the symbol type or symbol types that are held during the feature game may also be associated with awards that may be provided as discussed above.

It will also be understood that the selection of symbols that are displayed in the symbol positions 404 displaying non-held symbols 406 for each play of the feature game may be selected, in some implementations, in a manner similar to how they are selected during base game play. For example, randomized selections of symbols from virtual reel strips may be made for each play of the feature game, with the symbols 406 that would normally be displayed in the symbol positions 404 with held symbols not being displayed and the symbols 406 that are to be displayed in the symbol positions 404 that do not display held symbols 406 being displayed. In other implementations, such symbol selections in the feature game may be made using other mechanisms, e.g., from a separate set of virtual reel strips that differs from the virtual reel strips used in the base game.

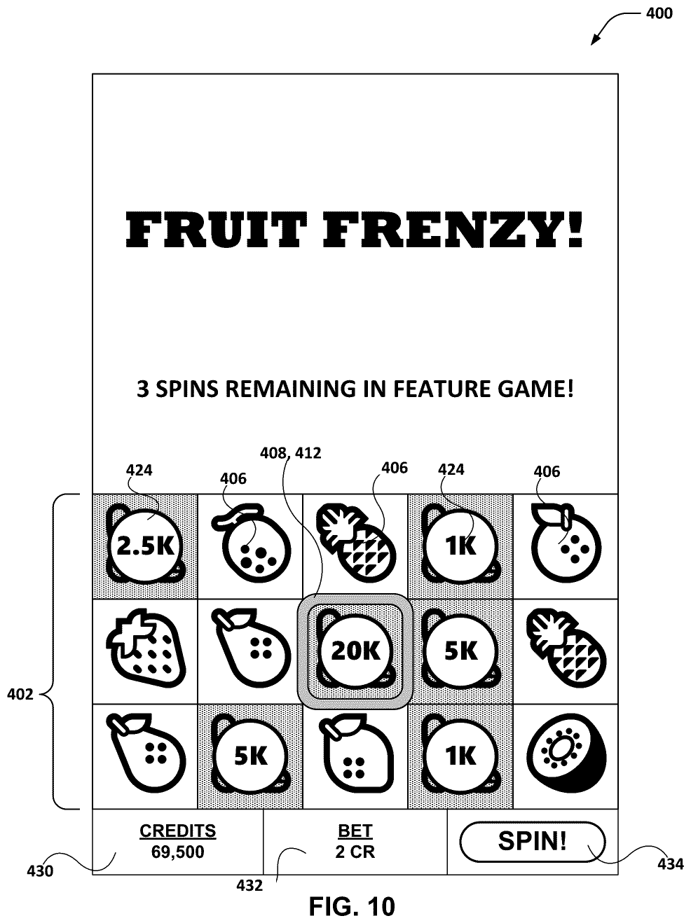

In the example feature game illustrated in FIGS. 10 through 14, the feature game trigger symbols (the six “banana” symbols of FIG. 10) are held in the start of the feature game. Moreover, each feature game trigger symbol is associated with an award (in this case, a credit award) and the awards provided to the player at the start of the feature game. For example, the credit indicator 430 now reflects a total of 69,500 credits since the 35,000 credits from FIG. 9 have been augmented by another 34,500 credits resulting from the awards 424 associated with the various feature game trigger symbols. The information area above the reel display area 402 also includes an indication of the number of feature game plays remaining 428 (in this example, three feature game plays).

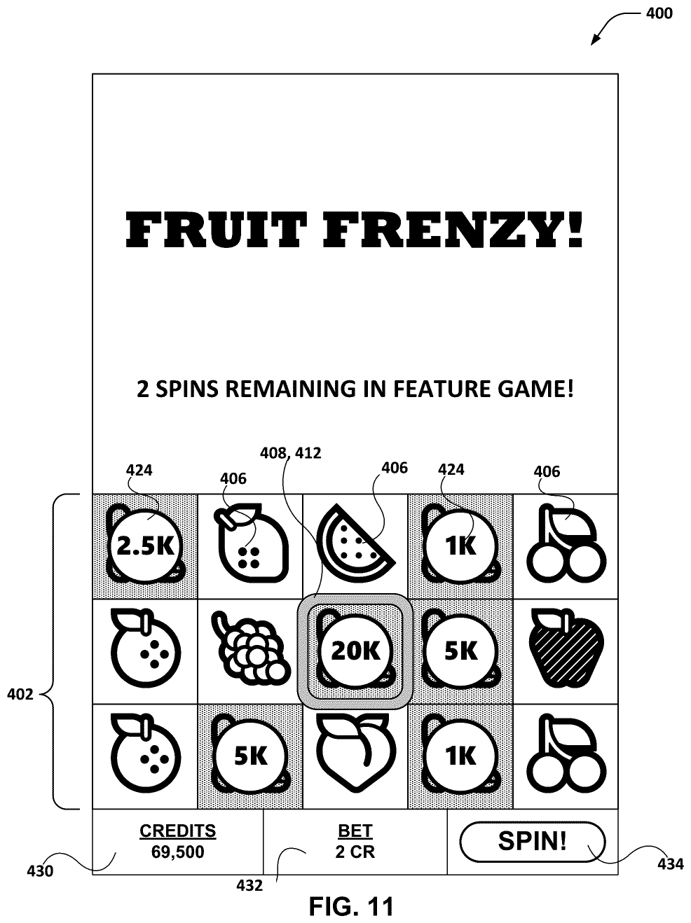

In FIG. 11, the player has initiated a first play of the feature game. However, none of the newly displayed symbols 406 is of the “banana” type of symbol, so the population of held symbols remains unchanged. Accordingly, the number of feature game plays remaining 428 has been decremented by one to reflect that the player has engaged in a play of the feature game that did not result in any newly held symbols 406.

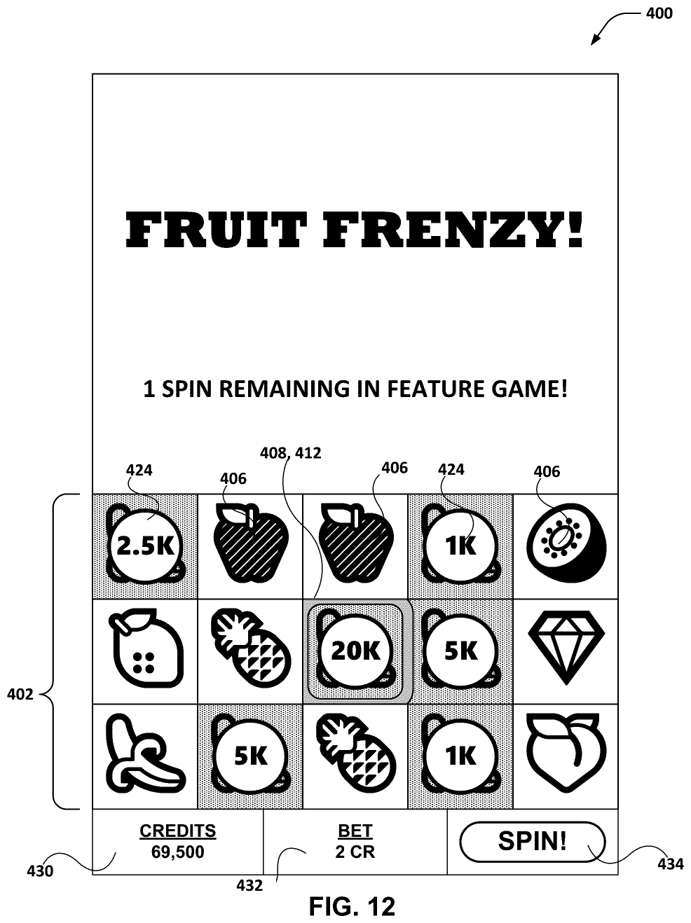

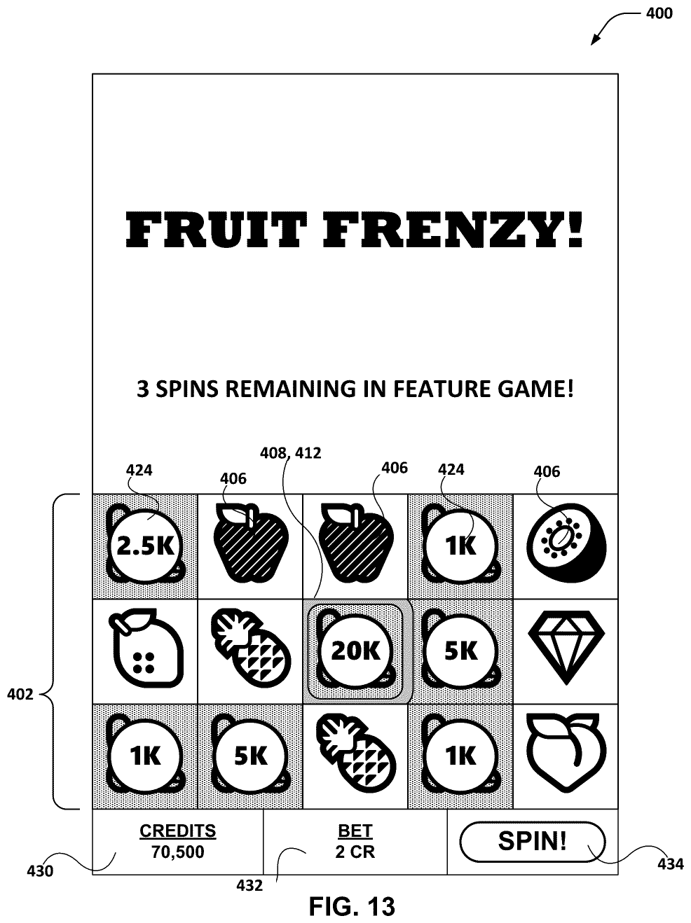

In FIG. 12, the player has initiated another play of the feature game—this time, a new symbol 406 that is of the type of symbol 406 that will be held in the feature game (a “banana” symbol in this example) has been displayed in the lower left symbol position 404. The number of feature game plays remaining 428 has been decremented again to reflect the additional play of the feature game, but, as is shown in FIG. 13, is then reset to three feature game plays, as shown in FIG. 13. Of course, the decrementing may simply be skipped in some implementations.

In FIG. 13, the newly held symbol 406 in the lower left symbol position 404 has been held. Additionally, the player has been awarded a credit value associated with that symbol 406, e.g., 1000 credits, causing the credit indicator 430 to increase from 69,500 credits to 70,500 credits.

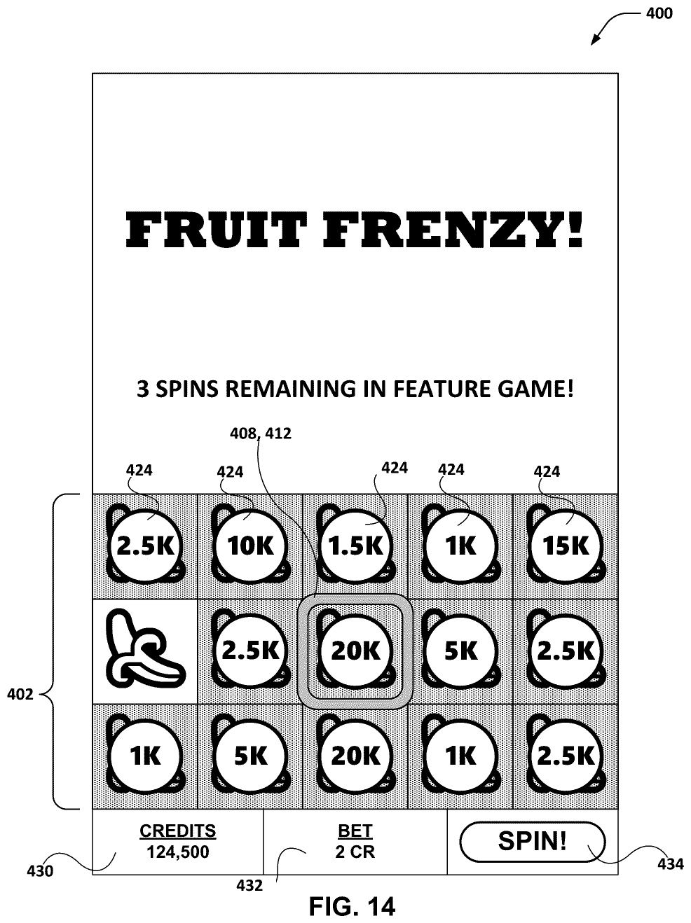

FIG. 14 represents the feature game after several additional plays of the feature game in which additional symbols 406 have been held in their respective symbol positions 404. In fact, the only remaining symbol position 404 that does not have a held symbol in it is the middle symbol position 404 at far left—and the symbol 406 that was displayed in that symbol position 404 as a result of the most recent play of the feature game is the type of symbol (a banana) that is held in the feature game implementation. An additional 54,000 credits have been added to the credit indicator as a result of the awards 424 indicated as being associated with the various additional held symbols 406.

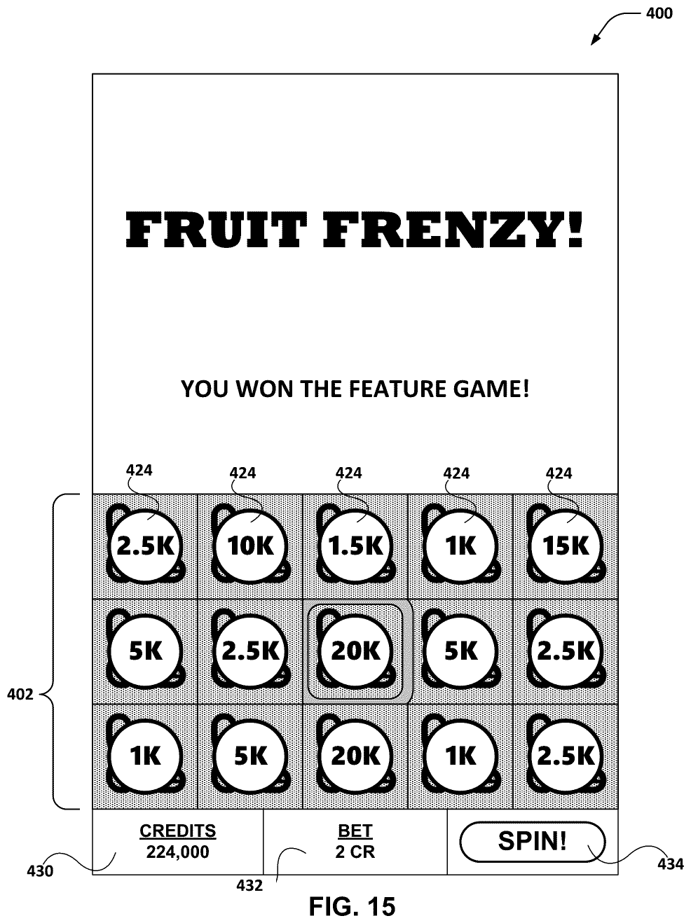

In FIG. 15, the information area above the reel display area 402 has been updated to indicate to the player that they have won the feature game. As can be seen, the last symbol to be held in the reel display area 402 has a 5000 credit award associated with it. The total credits in the lower left corner have thus been updated to include not only the additional 5000 credit amount, but to also include the awards associated with all of the held symbols 406 shown in the reel display area 402, thereby causing the credit indicator 430 to reflect a total of 224,000 credits (in this example, achieving a condition in which all of the symbol positions 404 in the reel display area 402 feature “held” symbols results in a double-payout of all of the awards associated with the displayed held symbols—once as the symbols are obtained, and then again at the conclusion of the feature game).

Once the feature game concludes, play may return to the base game.

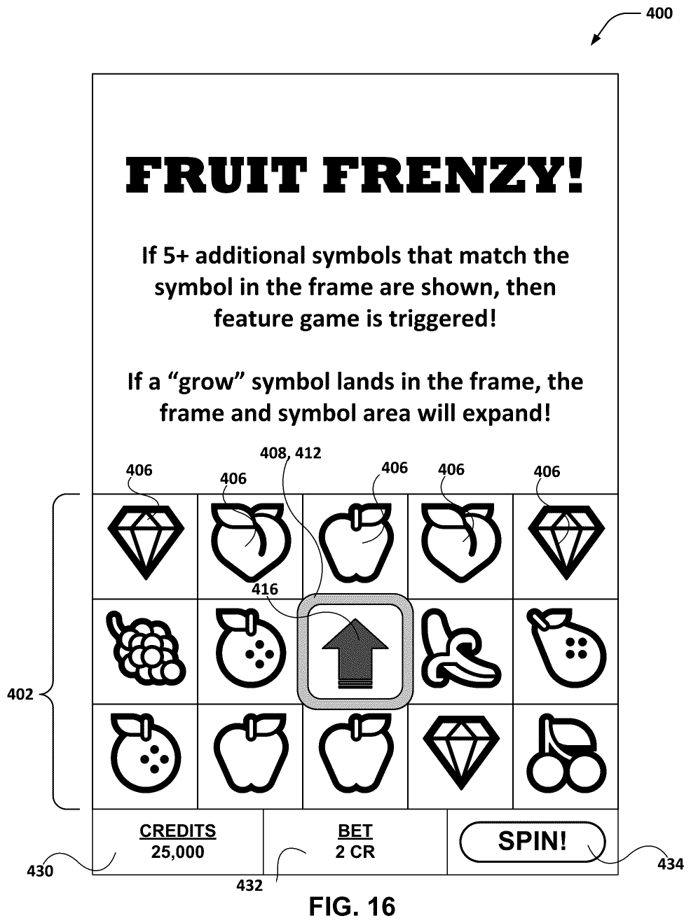

As noted earlier, in some implementations, a game of chance such as is described above may include a special type or types of symbols that may, if they are displayed in a symbol position in the first proper subset of symbol positions, cause the first proper subset to grow, i.e., to expand to include one or more additional symbol positions. Such an implementation is discussed further with reference to FIGS. 16 through 19.

In FIG. 16, the GUI 400 of earlier Figures is shown after a play of the base game. As can be seen in FIG. 16, a symbol 406 of a first type of symbol 416 has been shown in the symbol position 404 of the first proper subset 408 of the symbol positions 404. The first type of symbol 416 is a special type of symbol that causes the first proper subset 408 of symbol positions 404 to expand in size, i.e., to include one or more additional symbol positions 404. In some implementations, it may be possible for only one symbol 406 of the first type of symbol 416 to be displayed in the reel display area 402 at a time, e.g., there may be only one symbol 406 of the first type of symbol (and only one first type of symbol 406) in the entire population of symbols 406 that may be displayed in the symbol positions 404. In some such implementations, the display of such a symbol 406 in the first proper subset 408 of symbol positions 404 may cause the first proper subset 408 of symbol positions 404 to expand by one symbol position 404, but in other such implementations, the display of such a symbol 406 in the first proper subset 408 of symbol positions 404 may cause the first proper subset 408 of symbol positions 404 to expand by at least two symbol positions 404.

In FIG. 16, the symbol 406 that is the first type of symbol 416 is an arrow pointing upwards, indicating that the frame 412 is to be expanded to include additional symbol positions 404. Of course, other symbols may be used to indicate that the first proper subset 408 is to be expanded as well.

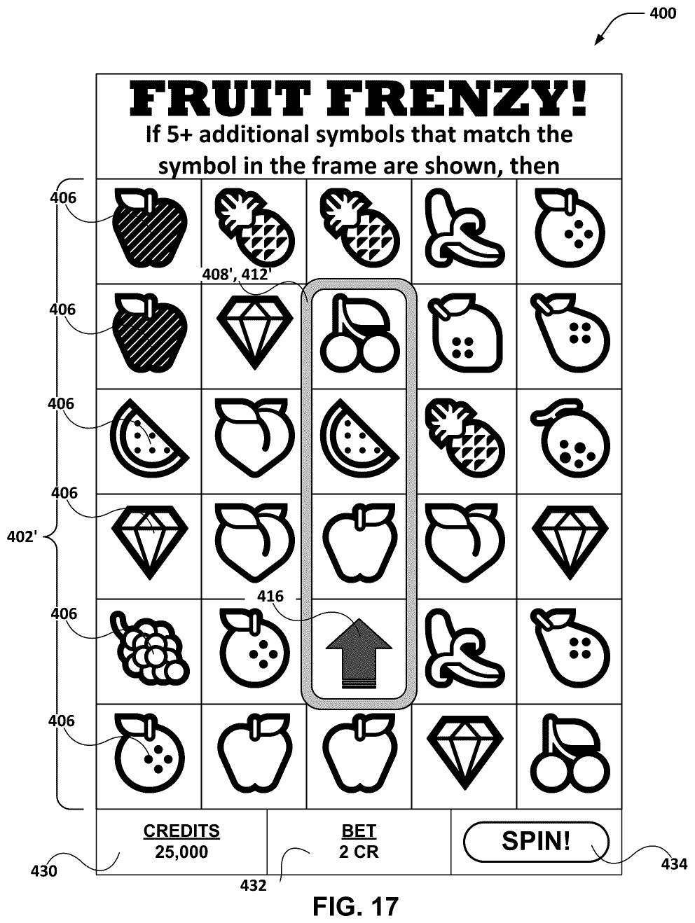

In FIG. 17, two different expansions have occurred as a result of the first type of symbol 416 being displayed in a symbol position 404 in the first proper subset 408 of symbol positions 404. In the first expansion, the size of the reel display area 402 has been expanded to include additional symbol positions. Thus, the size of the reel display area 402 has increased from an X by Y array of N symbol positions to M+N symbol positions, with M being an integer multiple of X (or of Y, depending on how X and Y are defined). In the depicted example, the expansion of the reel display area 402 is necessary since the second expansion, i.e., of the first proper subset 408 of symbol positions 404, includes symbol positions 404 that are not in the pre-expanded reel display area 402 and results in the frame 412 extending beyond the bounds of the reel display area 402 prior to expansion. However, if the expanded first proper subset 408 of symbol positions 404 were to include only symbol positions 404 that fell within the pre-expanded reel display area 402, the expansion of the reel display area 402 may not be needed and may, in some implementations, be omitted.

In FIG. 17, the first proper subset 408 of symbol positions 404 has expanded to include three additional symbol positions 404 beyond the original single symbol position 404. The three additional symbol positions 404 are arranged in a linear array, e.g., above the original symbol position 404 that was in the pre-expanded first proper subset 408 of symbol positions 404, but other implementations may feature different arrangements of symbol positions 404 that are in the expanded first proper subset 408 of symbol positions 404.

The amount by which the first proper subset 408 of symbol positions 404 is expanded when a symbol 406 of the first type of symbol 416 is displayed in a symbol position 404 in the first proper subset 408 of symbol positions 404 may be determined in various ways depending on the particular implementation. In some implementations, the amount may simply be a fixed value that does not change. In other implementations, the amount may be randomized, e.g., expanded by between one to four symbol positions (randomly selected, potentially in a weighted fashion). In yet further implementations, the amount may be determined based on actions of the player. For example, the amount may be selected based on the bet level or wager amount the player used when initiating the play of the base game that resulted in the expansion of the first proper subset 408 of symbol positions 404. There may be multiple bet levels or wager amounts that the player may select between, with the use of higher bet levels or wager amounts causing the first proper subset 408 of symbol positions 404 to increase by a larger amount than when lower bet levels or wager amounts are used.

As can be seen, there are now three symbols 406 of three different types of symbols 406 in the expanded first proper subset 408 in addition to the symbol 406 of the first type of symbol 416—a symbol 406 that is a cherry, a symbol 406 that is a watermelon, and a symbol 406 that is an apple.

It will be appreciated that in some implementations in which an expanded first proper subset of symbol positions includes a linear array of Z symbol positions, the set of symbols from which the symbols that are to be displayed in the first proper subset of symbol positions are drawn may be a sequenced group of symbols that include a sub-sequence of Z symbols that includes one symbol that is of the first type of symbol, e.g., a “grow” symbol. The symbols in the sub-sequence may, in some cases, not include any symbols that repeat within the sub-sequence. In some such cases, the symbol of the first type of symbol may be at the start or end of the sub-sequence. Such an arrangement ensures that the player will feel that they have gotten “full value” when the expansion of the first proper subset occurs, e.g., by avoiding a scenario in which the expanded first proper subset of symbol positions includes two symbols of the same type (thus losing an opportunity to have an additional symbol type act as a feature game trigger symbol).

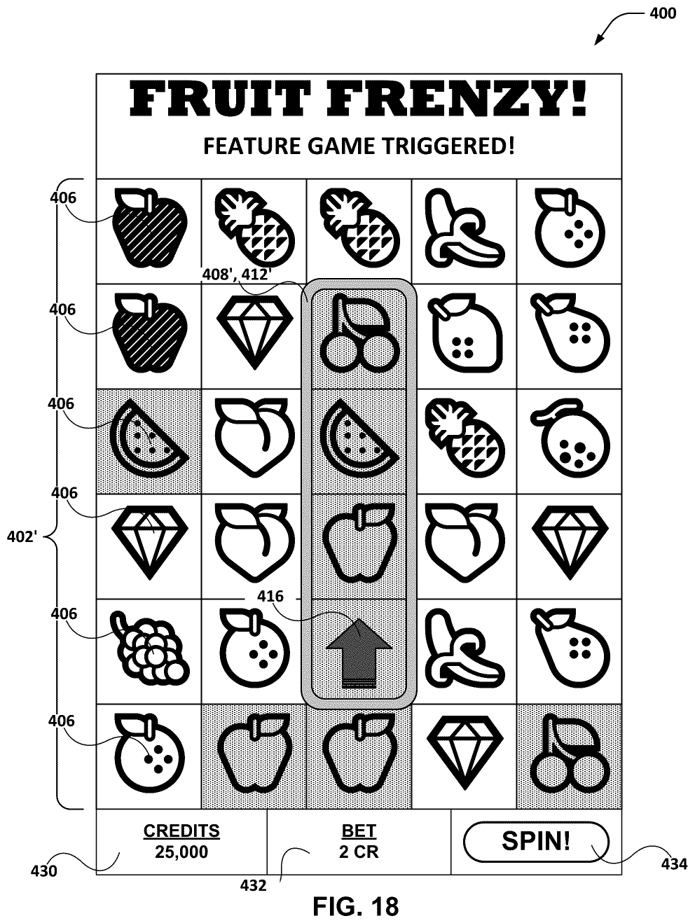

In FIG. 18, all of the symbol positions 404 showing symbols 406 of the same type as any of the symbols 406 in the first proper subset 408 of symbol positions 404 are indicated by gray shading. As can be seen, there are two cherry symbols 406, two watermelon symbols 406, three apple symbols 406, and the up-arrow symbol 406 that are shaded, indicating a total of eight feature game trigger symbols that are displayed in the expanded reel display area 402. This is sufficient to trigger the feature game, which is, in this example, triggered when there are six or more feature game trigger symbols displayed as a result of the base game outcome.

It will also be appreciated that winning symbol patterns in the base game, e.g., such as along paylines such as those presented in FIG. 5, may also be evaluated (as discussed with respect to FIG. 5) in the expanded reel display area 402, e.g., along additional paylines 418 that extend through one or more symbol positions 404 in the expanded portion of the reel display area 402.

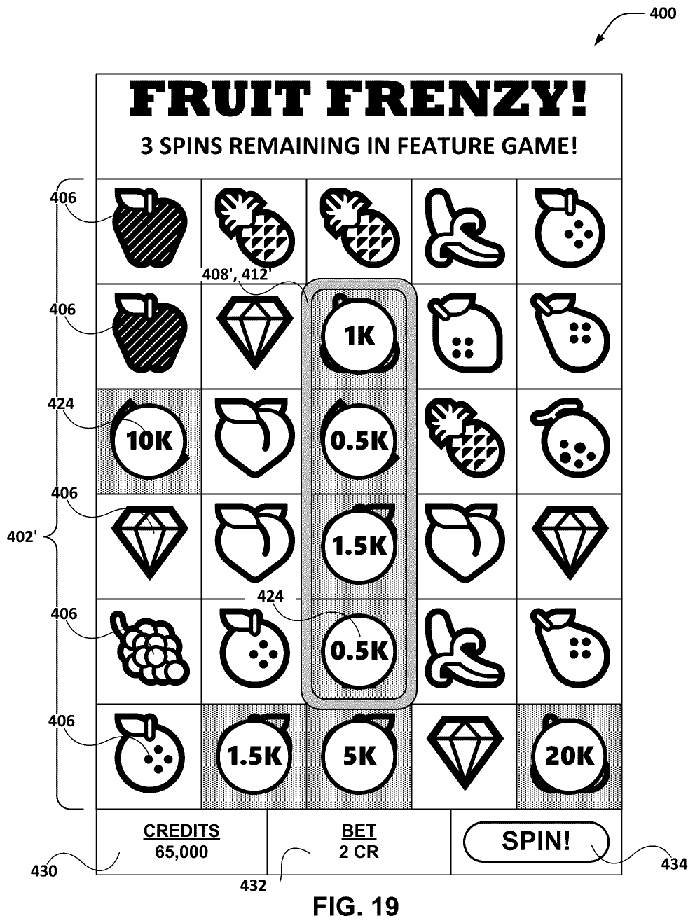

In FIG. 19, each feature game trigger symbol has had an award 424 associated therewith displayed, and the awards associated therewith have been awarded to the player (resulting, in this case, in the credit indicator 430 increasing in value from 25,000 credits to 65,000 credits. At this stage, the GUI 400 is prepared for play of the feature game, which may be operated in a manner similar to how the feature game is operated with respect to FIGS. 9 through 15, but with more symbol positions 404 available (thus increasing the odds of having a new symbol or symbols held each play of the feature game and consequently prolonging feature game play, but also making it more difficult to achieve the status of having all symbol positions in the reel display area have held symbols).

It will be appreciated that the above feature game triggering systems involving first proper subsets 408 of symbol positions 404 may be implemented in a base game in a number of ways. In some implementations, the first proper subset 408 may always be present for each play of the base game and in the same location. In some additional implementations, the first proper subset 408 may always be present for each play of the base game but the size and/or location of the first proper subset 408, i.e., the specific symbol positions 404 that are in the first proper subset 408, may be varied between plays of the base game, e.g., randomly or according to a predetermined pattern or schedule.

In some alternate implementations, a determination may be made prior to each play of the base game as to whether or not the first proper subset 408 will be active and/or available during the upcoming play of the base game. Such determinations may be random, e.g., each play of the base game has a percentage chance of having the first proper subset 408 active and displayed, according to a schedule (e.g., every fifth play of the base game), or responsive to an event or user action, e.g., the display of a particular symbol in the reel display area during a play of the base game may cause the first proper subset 408 to be presented and active during the next play of the base game or, alternatively, the first proper subset 408 may be presented and active during the next play of the base game in response to a player action, e.g., if the player makes a wager of a certain amount, redeems an in-game benefit awarded earlier, or pays a premium (e.g., in credits or digital or real currency). Similarly, the size of the first proper subset 408 may also be determined prior to a base game play according to various techniques, e.g., through random selection between a plurality of different preset sizes (one, two, three, or four symbol positions 404, for example), based on a size of a wager placed by the player (for example, if there are three different wager amounts that the player can select between, each wager amount may be associated with a first proper subset 408 having a different number of symbol positions 404 in it—with higher wager amounts being associated with first proper subsets 408 having a higher number of symbol positions 404 in them), based on the size of the first proper subset 408 most displayed most recently prior to the current game play (for example, the size of the first proper subset 408 may grow by one symbol position 404 each successive time the first proper subset 408 is made active during base game play, returning to a base level of symbol positions 404, e.g., one symbol position 404, after a pre-defined maximum number of symbol positions 404, e.g., four symbol positions 404, are displayed), based on symbols shown in prior base game outcomes (for example, some of the symbols that may be displayed during a base game outcome may be special symbols that may each cause a counter reflecting the number of symbol positions 404 that will be in the first proper subset 408 (should it be made active) to be incremented up or down by some value, e.g., by one—thus, each play of the base game may result in the number of symbol positions 404 that will be in the first proper subset 408 to increase, decrease, or remain the same), etc.

In yet some further implementations, the GUI may be configured to present an interface that allows a player to select the location of the first proper subset 408 for one or more plays of the base game. For example, the GUI may present an on-screen prompt that instructs the user to select one of the symbol positions 404 in the reel display area 402 (or, in some cases, one of the symbol positions 404 in a sub-region of the reel display area). Alternatively, the prompt may instruct the player to select a column or row of symbol positions 404, and the first proper subset 408 may be positioned to include one of the symbol positions 404 in the selected column or row. For example, for a reel display area 402 having five columns of three symbol positions 404, the first proper subset 408 may be configured to always be presented in the middle row of symbol positions, but the user may select in which column the first proper subset 408 is located. Thus, for example, such an interface may allow a player to select a second proper subset of symbol positions and then, after such a selection or selections have been made, cause the first proper subset of symbol positions to either match the second proper subset of symbol positions or be otherwise based on the second proper subset of symbol positions. For example, the second proper subset of symbol positions may include only one symbol position that the player gets to select. The first proper subset of symbol positions may include two or more symbol positions and may be defined such that a particular pattern of symbol positions has a particular symbol position that is caused to align with the symbol position in the second proper subset of symbol positions.

It will be understood that the techniques for providing a game of chance GUI discussed above may be implemented in systems in which symbols for display in symbol positions of a reel display area are selected from symbol sets in which some of the symbols may vary from play to play of the base game. For example, some games of chance may select symbols from virtual reel strips in which sequences of symbols are defined. In some such implementations, some of the symbols in the virtual reel strips may be, in effect, placeholder symbols that may be replaced with other symbols prior to display (if selected for display). For example, a given reel strip may have a group of three placeholder symbols that are all to be replaced by symbols of the same type prior to being displayed as part of a game play outcome. Thus, there may be two random determinations made (or a single one that is used to make two random determinations)—one that results in a random determination that one or more of the placeholder symbols is selected for display in a symbol position, and another that results in a random selection of a symbol type from a group of symbol types to ultimately display in place of the placeholder symbol.

It will be appreciated that references to random determinations made herein may refer to equally weighted random determinations, e.g., each potential outcome has the same chance of being randomly selected, or weighted random determinations, e.g., in which one or more potential outcomes has a higher or lower chance of being randomly selected as compared with one or more other potential outcomes.

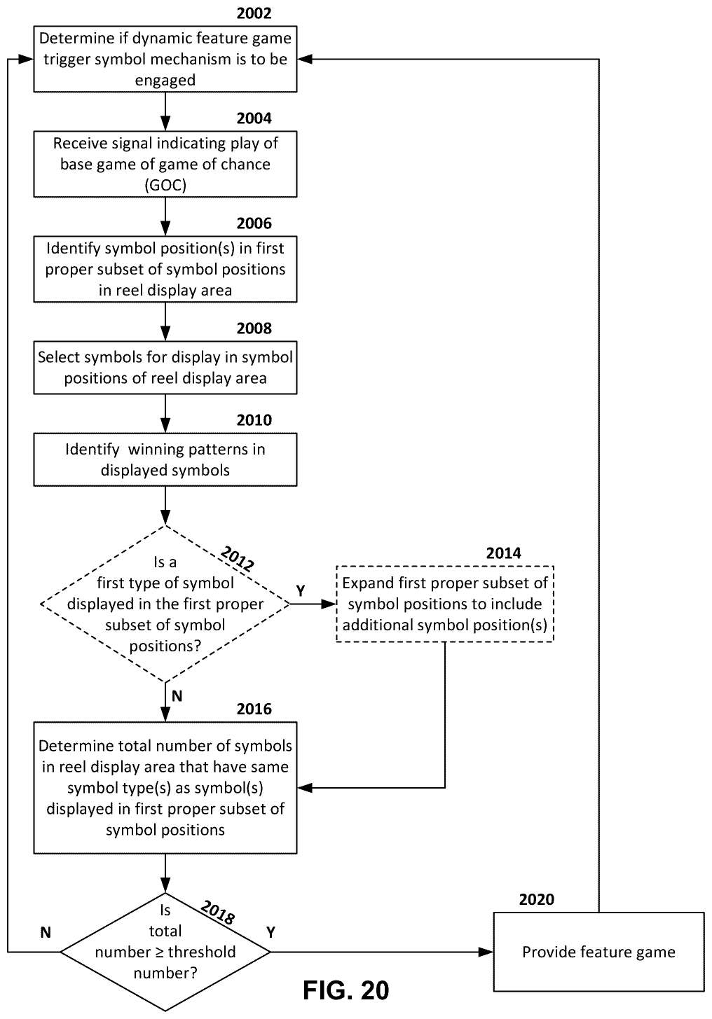

FIG. 20 depicts a flow chart of a technique for providing dynamic feature game trigger symbols in a GUI. In block 2002, a determination may be made as to whether a dynamic feature game trigger symbol mechanism is to be engaged for play of a base game portion of a game of chance. As noted above, in some implementations, such a determination may be automatic, e.g., every play of the base game portion of the game of chance will have the dynamic feature game trigger symbol mechanism active, in which a separate determination may be unnecessary and omitted. In some other implementations, however, the dynamic feature game trigger symbol mechanism may be made active or inactive at various points in time during play, as discussed earlier. In such implementations, the determination of block 2002 may be made. It is determined in block 2002 that the dynamic feature game trigger symbol mechanism is to be made inactive for the next play of the base game of the game of chance, then the base game may be presented without the dynamic feature game trigger symbol mechanism being active. However, if it is determined in block 2002 that the dynamic feature game trigger symbol mechanism is to be active for the next play of the base game of the game of chance, then the remainder of the technique of FIG. 20 may be implemented.

In block 2004, a signal may be received indicating a play of the base game of the game of chance, e.g., a signal generated by a user selection of a “play” button, e.g., play button 434. It will be appreciated that the determination in block 2002 of whether the dynamic feature game trigger symbol mechanism is to be active or not may also be made after, or as part of, block 2004 as well. Regardless, responsive to block 2004, the technique may proceed to block 2006, in which a determination may be made as to which symbol positions of a plurality of symbol positions displayed in a reel display area are to be part of a first proper subset of symbol positions. In some cases, the first proper subset of symbol positions may remain unchanged from play to play, in which case block 2006 may be omitted or may simply consist of referencing the same proper subset of symbol positions each time. In other cases, however, the first proper subset of symbol positions may, as noted earlier, change occasionally or, in some cases, for each play of the base game in which the dynamic feature game trigger symbol mechanism is active.

In block 2008, symbols may be selected for display in the symbol positions in the reel display area. Such symbol selection may, for example, be made using any of a variety of different techniques, e.g., including randomly selecting adjacent groups of symbols from a virtual reel strip, randomly selecting each symbol to be displayed from a plurality of symbols, etc. In some instances, there may be a plurality of different virtual reel strips having different sets of symbols. In such instances, selection of symbols for display may be made by, for example, selecting one of the sets of virtual reel strips (e.g., randomly or in a weighted random fashion) and then selecting symbols from the selected reel strips (again, via random determination). In some instances, virtual reel strips that are selected for use in determining which symbols to select may include symbols that are to be swapped out for replacement symbols for the purposes of determining a game outcome. For example, there may be one or more types of replacement symbols that are intended to be replaced by one or more symbols for display for the purposes of providing an outcome in the game of chance. The symbols that are used to replace the replacement symbols may, for example, be randomly selected. It will be understood that selecting symbols for display is inclusive of all such example techniques for selecting symbols, as well as other techniques not explicitly discussed herein.

In block 2010, any winning patterns that may exist within the displayed symbols may be identified, e.g., winning patterns along a payline or paylines. If the base game of the game of chance is a “ways” game, then the winning pattern may be achieved along any of the ways (each way being a unique combination of one symbol from each column of symbols, for example). If one or more such winning patterns are displayed, then an award associated with the winning pattern, e.g., credits, may be assigned to the player that is playing the game of chance.

In block 2012, a determination may be made as to whether a first type of symbol is displayed in the first proper subset of symbol positions. The first type of symbol may be more commonly referred to as a “grow” symbol. If the first proper subset of symbol positions includes a symbol position that includes the first type of symbol, then the technique may proceed to block 2014, in which one or more additional symbol positions may be added to the first proper subset of symbol positions (as discussed earlier), before progressing to block 2016. If it is determined in block 2012 that the first type of symbol is not in the first proper subset of symbol positions, then the technique may proceed directly to block 2016. It will be understood that in dynamic feature game trigger symbol mechanism-equipped games of chance that do not feature a “grow” aspect to the dynamic feature game trigger symbol mechanism, blocks 2012 and 2014 may simply be omitted and the technique may progress directly to block 2016 from block 2010.

In block 2016, a determination may be made as to the total number of symbols displayed in the reel display area that have the same symbol type(s) as symbol(s) displayed in the first proper subset of symbol positions. In block 2018, a determination may be made as to whether that total number of symbols meets or exceeds a threshold number of feature game trigger symbols needed to cause a feature game to be initiated. Optionally, in some implementations, a determination may be made, e.g., via random selection, as to whether an intermediate aware will be provided, e.g., by awarding the player with credit values that may be optionally associated with each of the feature game trigger symbols.

If it is determined in block 2018 that the total number meets or exceeds the threshold, the technique may proceed to block 2020, in which the feature game may be initiated and provided before returning to block 2002 after conclusion of the feature game. If it is determined in block 2018 that the total number does not meet or exceed the threshold, the technique may simply return to block 2002 for more play of the base game.

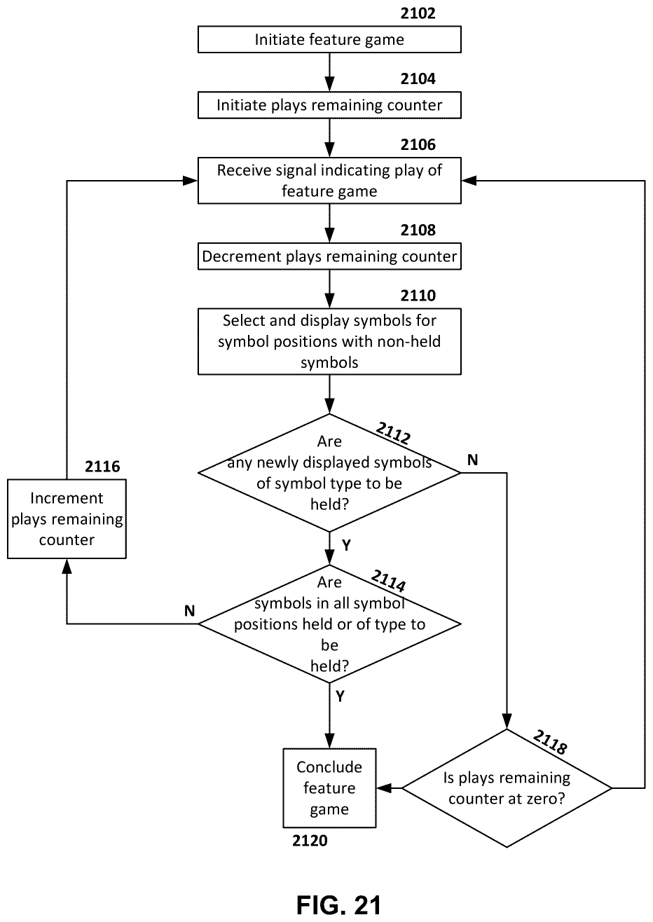

FIG. 21 depicts a flow chart for a technique for providing a feature game according to the present disclosure. It will be appreciated that any suitable feature game may be used in place of the example feature game, and that this example is just one example of many different types of feature game that may be usable in this context.

In FIG. 21, the technique begins in block 2102, in which the feature game may be initiated. In some instances, such initiation may include, for example, importing the feature game trigger symbols that triggered the feature game in the first place as “held” symbols within the reel display area for the purpose of the feature game. In block 2104, a plays remaining counter may be initialized to reflect a total number of feature game plays available to the player.

In block 2106, a signal may be received, e.g., from a play button 434, that indicates a play of the feature game. In block 2108, the plays remaining counter may be decremented to reflect the play of the feature game, and then, in block 2110, symbols may be selected and displayed for symbol positions in the reel display area that do not already have “held” symbols present.

In block 2112, a determination may be made as to whether any of the newly displayed symbols are of a symbol type to be held. If so, then the technique may proceed to block 2114, in which another determination may be made as to whether all symbol positions in the reel display area are held or of a type of symbol to be held. If it is determined in block 2114 that not all of the symbol positions in the reel display area display held symbols or symbols to be held, the technique may proceed to block 2116, in which the plays remaining counter may be incremented before the technique returns to block 2106 to await receipt of a further signal indicating play of the feature game. If it is determined in block 2114 that all of the symbol positions in the reel display area display held symbols or symbols to be held, the technique may proceed to block 2120, in which the feature game may conclude. Block 2120 may include, for example, determining a win amount associated with the feature game.

If it is determined in block 2112 that there are no newly displayed symbols of the symbol type to be held, then the technique may proceed to block 2118, in which a determination may be made as to whether the plays remaining counter is at zero—if so, the technique may proceed to block 2120, where the feature game is concluded. If not, the technique may proceed to return to 2106 to await receipt of a further signal indicating play of the feature game.

It will be understood that in the discussion of the above techniques, some elements discussed earlier have not been referenced. It will be understood, however, that such elements may be incorporated into such techniques, e.g., elements such as awarding credits for each feature game trigger symbol that is shown, or each time a new held symbol is displayed.

It will be understood that the various GUIs discussed herein may be implemented entirely locally, e.g., by a processor or processors of a single device, such as a smartphone, or may be provided using processors located in different devices or systems. Information regarding the selection of symbols, awards associated with feature game trigger symbols, etc., may be transmitted, e.g., via a network connection (wired, wireless, or a mixture of both) to another device, e.g., a smartphone, the processor or processors of which may then implement the GUI using the information symbols, awards, etc. Such information may be generated and/or sent in response to receipt of a request from such another device, e.g., a request from a smartphone for the server to provide such information. Such distributed-computing implementations of the GUI provisioning techniques discussed herein is to be understood to also be within the scope of this disclosure.

It will be appreciated that in such distributed computing arrangements, the computer-executable instructions for implementing the GUI may be distributed between different memory devices located in different devices, e.g., the computer-executable instructions for selecting symbols stored on one or more memory devices of a server, while computer-executable instructions presenting the GUI.

In recognition of the possibility of such distributed processing arrangements, the term “collectively,” as used herein with reference to memory devices and/or processors or various other items, should be understood to indicate that the referenced collection of items has the characteristics or provides the functionalities that are associated with that collection. For example, if a server and a client device collectively store instructions for causing A, B, and C to occur, this encompasses at least the following scenarios:
a) The server stores instructions for causing A, B, and C to occur, but the client device stores no instructions that cause A, B, and C to occur.
b) The client device stores instructions for causing A, B, and C to occur, but the server stores no instructions that cause A, B, and C to occur.
c) The server stores instructions for causing a proper subset of A, B, and C to occur, e.g., A and B but not C, and the client device stores instructions that cause a different proper subset of A, B, and C to occur, e.g., C but not A and B, where instructions for causing each of A, B, and C to occur are respectively stored on either or both the client device and the server.
d) The server stores instructions for causing a subset of A, B, and C to occur, e.g., A and B but not C, and the client device stores instructions that cause a different subset of A, B, and C to occur, e.g., B and C but not A, where instructions for causing each of A, B, and C to occur are respectively stored on either or both the client device and the server.
e) The server stores instructions for causing A and a portion of B to occur, and the client device stores instructions that cause C and the remaining portion of B to occur.

In all of the above scenarios, between the server and the client device, there are, collectively, instructions that are stored for causing A, B, and C to occur, i.e., such instructions are stored on one or both devices and it will be recognized that using the term “collectively,” e.g., the server and the client device, collectively, store instructions for causing A, B, and C to occur, encompasses all of the above scenarios as well as additional, similar scenarios.

Similarly, a collection of processors, e.g., a first set of one or more processors and a second set of one or more processors, may be caused, collectively, to, perform one or more actions, e.g., actions A, B, and C. As with the previous example, various permutations fall within the scope of such “collective” language:
a) The first set of one or more processors may be caused to perform each of A, B, and C, and the second set of one or more processors may not perform any of A, B, or C.
b) The second set of one or more processors may be caused to perform each of A, B, and C, and the first set of one or more processors may not perform any of A, B, or C.
c) The first set of one or more processors may be caused to perform a proper subset of A, B, and C, and the second set of one or more processors may be caused to perform a different proper subset of A, B, and C to be performed such that between the two sets of processors, all of A, B, and C are caused to be performed.
d) The first set of one or more processors may be caused to perform A and a portion of B, and the second set of one or more processors may be caused to perform C and the remainder of B.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system comprising:
one or more displays,
one or more processors, and
one or more memory devices, the one or more memory devices storing computer-executable instructions which, when executed by the one or more processors, cause the one or more processors to:
cause a graphical user interface for a game of chance to be presented on the one or more displays, the graphical user interface including a plurality of N symbol positions,
cause, for each symbol position and responsive to a signal indicating a play of the game of chance, a corresponding symbol to be displayed therein, wherein each displayed symbol is one of a plurality of different types of symbols,
determine a first proper subset of the symbol positions,
determine a first quantity of the symbols that are in a first set of one or more of the symbols, the first set of one or more of the symbols consisting of the displayed symbol or symbols that is or are of the same type of symbol as any symbol displayed in the first proper subset of the symbol positions,
determine, for the play of the game of chance, whether a subset of the displayed symbols forms a winning pattern, and
cause a feature game to be initiated responsive to the first quantity being greater than or equal to a first threshold.

2. The system of claim 1, wherein the one or more memory devices further store additional computer-executable instructions which, when executed by the one or more processors, further cause the one or more processors to:
associate a value with each symbol in the first set of one or more of the symbols; and
determine an award based, at least in part, on the values associated with the symbol or symbols in the first set of one or more of the symbols.

3. The system of claim 1, wherein the one or more memory devices further store additional computer-executable instructions which, when executed by the one or more processors, further cause the one or more processors to determine the first proper subset of the symbol positions by randomly selecting one or more of the symbol positions.

4. The system of claim 1, wherein:
the plurality of different types of symbols includes a first type of symbol, and
the one or more memory devices further store additional computer-executable instructions which, when executed by the one or more processors, further cause the one or more processors to:
determine whether a symbol of the first type of symbol is displayed in the symbol position or one of the symbol positions in the first proper subset of the symbol positions, and
increase, responsive to determining that a symbol of the first type of symbol is displayed in the symbol position or one of the symbol positions in the first proper subset of the symbol positions, the number of symbol positions in the first proper subset of symbol positions prior to determining the first quantity of the symbols that are in the first set of one or more of the symbols.

5. The system of claim 4, wherein, after the number of symbol positions in the first proper subset of symbol positions is increased, the symbol positions in the first proper subset of the symbol positions are arranged in a linear array of symbol positions, each symbol position at either end of the linear array adjacent to another symbol position in the linear array, and each symbol position, if any, in the linear array and not at either end of the linear array adjacent to two other symbol positions in the linear array.

6. The system of claim 4, wherein the one or more memory devices further store additional computer-executable instructions which, when executed by the one or more processors, further cause the one or more processors to cause the GUI to include N+M symbol positions responsive to determining that a symbol of the first type of symbol is displayed in the symbol position or one of the symbol positions in the first proper subset of the symbol positions, wherein M is a positive integer.

7. The system of claim 6, wherein the feature game is a hold-and-spin game that uses the N+M symbol positions.

8. One or more non-transitory, computer-readable media storing computer-executable instructions which, when executed by one or more processors, cause the one or more processors to:
cause a graphical user interface for a game of chance to be presented on one or more displays, the graphical user interface including a plurality of N symbol positions;
cause, for each symbol position and responsive to a signal indicating a play of the game of chance, a corresponding symbol to be displayed therein, wherein each displayed symbol is one of a plurality of different types of symbols;
determine a first proper subset of the symbol positions;
determine a first quantity of the symbols that are in a first set of one or more of the symbols, the first set of one or more of the symbols consisting of the displayed symbol or symbols that is or are of the same type of symbol as any symbol displayed in the first proper subset of the symbol positions;
determine, for the play of the game of chance, whether a subset of the displayed symbols forms a winning pattern; and
cause a feature game to be initiated responsive to the first quantity being greater than or equal to a first threshold.

9. The one or more non-transitory, computer-readable media of claim 8, further storing additional computer-executable instructions which, when executed by the one or more processors, further cause the one or more processors to:
associate a value with each symbol in the first set of one or more of the symbols; and
determine an award based, at least in part, on the values associated with the symbol or symbols in the first set of one or more of the symbols.

10. The one or more non-transitory, computer-readable media of claim 8, further storing additional computer-executable instructions which, when executed by the one or more processors, further cause the one or more processors to determine the first proper subset of the symbol positions by randomly selecting one or more of the symbol positions.

11. The one or more non-transitory, computer-readable media of claim 8, wherein:
the plurality of different types of symbols includes a first type of symbol, and
the one or more non-transitory, computer-readable media further store additional computer-executable instructions which, when executed by the one or more processors, further cause the one or more processors to:
determine whether a symbol of the first type of symbol is displayed in the symbol position or one of the symbol positions in the first proper subset of the symbol positions, and
increase, responsive to determining that a symbol of the first type of symbol is displayed in the symbol position or one of the symbol positions in the first proper subset of the symbol positions, the number of symbol positions in the first proper subset of symbol positions prior to determining the first quantity of the symbols that are in the first set of one or more of the symbols.

12. The one or more non-transitory, computer-readable media of claim 11, wherein, after the number of symbol positions in the first proper subset of symbol positions is increased, the symbol positions in the first proper subset of the symbol positions are arranged in a linear array of symbol positions, each symbol position at either end of the linear array adjacent to another symbol position in the linear array, and each symbol position, if any, in the linear array and not at either end of the linear array adjacent to two other symbol positions in the linear array.

13. The one or more non-transitory, computer-readable media of claim 11, further storing additional computer-executable instructions which, when executed by the one or more processors, further cause the one or more processors to cause the GUI to include N+M symbol positions responsive to determining that a symbol of the first type of symbol is displayed in the symbol position or one of the symbol positions in the first proper subset of the symbol positions, wherein M is a positive integer.

14. The one or more non-transitory, computer-readable media of claim 13, wherein the feature game is a hold-and-spin game that uses the N+M symbol positions.

15. A method comprising:
causing a graphical user interface for a game of chance to be presented on one or more displays, the graphical user interface including a plurality of N symbol positions,
causing, for each symbol position and responsive to a signal indicating a play of the game of chance, a corresponding symbol to be displayed therein, wherein each displayed symbol is one of a plurality of different types of symbols,
determining a first proper subset of the symbol positions,
determining a first quantity of the symbols that are in a first set of one or more of the symbols, the first set of one or more of the symbols consisting of the displayed symbol or symbols that is or are of the same type of symbol as any symbol displayed in the first proper subset of the symbol positions,
determining, for the play of the game of chance, whether a subset of the displayed symbols forms a winning pattern, and
causing a feature game to be initiated responsive to the first quantity being greater than or equal to a first threshold.

16. The method of claim 15, further comprising:
associating a value with each symbol in the first set of one or more of the symbols; and
determining an award based, at least in part, on the values associated with the symbol or symbols in the first set of one or more of the symbols.

17. The method of claim 15, further comprising determining the first proper subset of the symbol positions by randomly selecting one or more of the symbol positions.

18. The method of claim 15, wherein:
the plurality of different types of symbols includes a first type of symbol, and
the method further comprises:
determining whether a symbol of the first type of symbol is displayed in the symbol position or one of the symbol positions in the first proper subset of the symbol positions, and
increasing, responsive to determining that a symbol of the first type of symbol is displayed in the symbol position or one of the symbol positions in the first proper subset of the symbol positions, the number of symbol positions in the first proper subset of symbol positions prior to determining the first quantity of the symbols that are in the first set of one or more of the symbols.

19. The method of claim 18, further comprising causing the GUI to include N+M symbol positions responsive to determining that a symbol of the first type of symbol is displayed in the symbol position or one of the symbol positions in the first proper subset of the symbol positions, wherein M is a positive integer.

20. The method of claim 19, wherein the feature game is a hold-and-spin game that uses the N+M symbol positions.
